(19) United States
(12) Patent Application Publication
(10) Pub. No.: US 2015/0299529 A1
(43) Pub. Date: Oct. 22, 2015

(54) FIRE-RESISTANT ADHESIVE TAPE, FIRE-RESISTANT CONSTRUCTION MATERIAL AND FIRE-RESISTANT TREATMENT METHOD

(71) Applicant: NITTO DENKO CORPORATION, Osaka (JP)

(72) Inventors: Kohei DOI, Ibaraki-shi (JP); Kunio NAGASAKI, Ibaraki-shi (JP); Yusuke SUGINO, Ibaraki-shi (JP); Takafumi HIDA, Ibaraki-shi (JP); Yusuke NAKAYAMA, Ibaraki-shi (JP)

(73) Assignee: NITTO DENKO CORPORATION, Osaka (JP)

(21) Appl. No.: 14/378,370

(22) PCT Filed: Mar. 7, 2013
(86) PCT No.: PCT/JP2013/056248

§ 371 Date: Aug. 13, 2014

(30) Foreign Application Priority Data
Mar. 16, 2012 (JP) 2012-059673
Mar. 16, 2012 (JP) 2012-059674
Mar. 16, 2012 (JP) 2012-059675

(51) Int. Cl. C09J 133/00; B32B 3/26; C09J 7/02; B32B 27/08; B32B 27/32; B32B 27/30; B32B 15/20; B32B 15/082

(52) U.S. Cl. CPC C09J 133/00; B32B 15/20; B32B 3/266; B32B 15/082; B32B 27/08; B32B 27/32; B32B 27/304; C09J 7/0292; C09J 7/0296; C09J 7/0278; C09J 7/0271; B32B 2307/3065; B32B 2405/00; B32B 2419/00; B32B 2607/00; C09J 2423/006

(57) ABSTRACT

Provided is technical means for making various base materials non-combustible to improve fire resistance, the technical means being capable of imparting sufficiently high fire resistance, which meets the accreditation criteria for a fire-proof material under the Building Standard Law to the extent possible, to the various base materials with ease at low cost. Also provided is a fire-resistant construction material having sufficiently high fire resistance, which meets the accreditation criteria for a fire-proof material under the Building Standard Law to the extent possible, with ease at low cost. A fire-resistant pressure-sensitive adhesive tape of the present invention is a fire-resistant pressure-sensitive adhesive tape, including: a fire-resistant layer; and a pressure-sensitive adhesive layer, in which the fire-resistant layer includes aluminum. A fire-resistant construction material of the present invention includes: a member; and the fire-resistant pressure-sensitive adhesive tape of the present invention bonded to at least one surface of the member.

### TECHNICAL FIELD

The present invention relates to a fire-resistant pressure-sensitive adhesive tape, a fire-resistant construction material, and a fire-resistant treatment method.

### BACKGROUND ART

There are many construction materials required to have fire resistance such as a ceiling material for buildings, a floor material for buildings, a wall surface material for buildings, a ceiling material for railway vehicles, a floor material for railway vehicles, a wall surface material for railway vehicles, an interior material for aircraft, and a material for ships (e.g., a fire-proof partition). Most of such construction materials include various base materials such as paper, a lumber board, and a resin board. Accordingly, there is a demand for a technology for making the base materials non-combustible to improve fire resistance.

An outline of the accreditation criteria for a fire-proof material under the Building Standard Law is as follows: in heating combustion at an irradiance intensity of 50 kW/m² for 20 minutes by a cone calorimeter test, (1) a total heat release of 8 MJ/m² or less, (2) a time for heat release exceeding 200 kW/m² of less than 10 seconds, and (3) absence of a crack or perforation reaching a back surface.

Thus, in light of the Building Standard Law, in providing a fire-proof material, there is a strong demand for a technology for making various base materials non-combustible so as to meet the accreditation criteria to the extent possible.

However, there is no established technology capable of imparting sufficiently high fire resistance, which meets the accreditation criteria to the extent possible, to various base materials with ease at low cost.

In connection with the technology for making various base materials non-combustible, there is a proposal concerning a method involving using a flame-retardant resin sheet as a base material. A halogen-based resin such as a fluorine-based resin or a vinyl chloride resin is used as a material for such flame-retardant resin sheet (Patent Literature 1). However, there is a problem in that the halogen-based resin generates a harmful gas or dioxin when incinerated. Therefore, its use has been restricted in recent years.

In addition, in connection with the technology for making various base materials non-combustible, there is a proposal concerning a method involving adding a non-halogen-based flame retardant such as a phosphoric acid ester or a metal hydrate to a resin to be used as a material for a base material (Patent Literature 2). However, in this technology, the flame retardant needs to be added in a large amount. As a result, problems such as a reduction in transparency of a resin and a defect in external appearance occur.

Further, the related-art is not applicable to a case where materials for various base materials required to be made non-combustible are each one except a resin (e.g., lumber or paper).

In addition, a construction material required to have fire resistance desirably has an outermost surface protected with a surface protective layer with a view to, for example, blocking prevention or damage prevention. Hitherto, however, there has been no established technology for providing a construction material having such surface protective function and having high fire resistance.

### CITATION LIST

### Patent Literature

[PTL 1] JP 2005-015620 A
[PTL 2] JP 2001-040172 A

### SUMMARY OF INVENTION

### Technical Problem

An object of the present invention is to provide technical means for making various base materials non-combustible to improve fire resistance, the technical means being capable of imparting sufficiently high fire resistance, which meets the accreditation criteria for a fire-proof material under the Building Standard Law to the extent possible, to the various base materials with ease at low cost. Another object of the present invention is to provide a fire-resistant construction material having sufficiently high fire resistance, which meets the accreditation criteria for a fire-proof material under the Building Standard Law to the extent possible, with ease at low cost.

### Solution to Problem

The inventors of the present invention have focused attention on, as the technical means capable of imparting fire resistance to various base materials with ease at low cost, a technology for bonding a pressure-sensitive adhesive tape to the base materials, and have made studies on a pressure-sensitive adhesive tape capable of imparting sufficiently high fire resistance, which meets the accreditation criteria for fire-proof material under the Building Standard Law to the extent possible. Thus, the present invention has been completed.

A fire-resistant pressure-sensitive adhesive tape of the present invention is a fire-resistant pressure-sensitive adhesive tape including: a fire-resistant layer; and a pressure-sensitive adhesive layer, in which the fire-resistant layer includes aluminum.

In a preferred embodiment, the fire-resistant pressure-sensitive adhesive tape, further includes a surface protective layer on a side of the fire-resistant layer opposite to the pressure-sensitive adhesive layer.

In a preferred embodiment, the surface protective layer includes at least one kind selected from a surface protective material including a polyvinyl chloride-based film as a base and a surface protective material including a polyolefin-based film as a base.

In a preferred embodiment, a composite member obtained by bonding the fire-resistant pressure-sensitive adhesive tape to an adherend having a thickness of from 0.1 mm to 50 mm has a total heat release of 8 MJ/m² or less in heating combustion at an irradiance intensity of 50 kW/m² for 20 minutes by a cone calorimeter test in conformity to ASTM-E-1354.

In a preferred embodiment, a composite member obtained by bonding the fire-resistant pressure-sensitive adhesive tape to an adherend having a thickness of from 0.1 mm to 50 mm has a time for heat release exceeding 200 kW/m² of less than 10 seconds in heating combustion at an irradiance intensity of 50 kW/m² for 20 minutes by a cone calorimeter test in conformity to ASTM-E-1354.

In a preferred embodiment, a composite member obtained by bonding the fire-resistant pressure-sensitive adhesive tape to an adherend having a thickness of from 0.1 mm to 50 mm is free of a crack or perforation reaching a back surface thereof after heating combustion at an irradiance intensity of 50 kW/m² for 20 minutes by a cone calorimeter test in conformity to ASTM-E-1354.

In a preferred embodiment, the fire-resistant layer has a thickness of from 5 μm to 300 μm.

In a preferred embodiment, the fire-resistant layer includes any one of an aluminum foil, a laminate in which an aluminum foil is laminated, and a glass cloth aluminum foil.

In a preferred embodiment, the pressure-sensitive adhesive layer includes an acrylic pressure-sensitive adhesive.

In a preferred embodiment, the fire-resistant layer partially has an opening.

In a preferred embodiment, the pressure-sensitive adhesive layer has a thickness of from 5 μm to 2 mm.

A fire-resistant construction material of the present invention includes: a member; and the fire-resistant pressure-sensitive adhesive tape of the present invention bonded to at least one surface of the member.

In a preferred embodiment, the member includes a combustible member.

In a preferred embodiment, the combustible member includes at least one kind selected from paper, a lumber board, and a resin board.

In a preferred embodiment, the member has a thickness of from 0.1 mm to 50 mm.

In a preferred embodiment, the fire-resistant construction material of the present invention has a total heat release of 8 MJ/m² or less in heating combustion at an irradiance intensity of 50 kW/m² for 20 minutes by a cone calorimeter test in conformity to ASTM-E-1354.

In a preferred embodiment, the fire-resistant construction material of the present invention has a time for heat release exceeding 200 kW/m² of less than 10 seconds in heating combustion at an irradiance intensity of 50 kW/m² for 20 minutes by a cone calorimeter test in conformity to ASTM-E-1354.

In a preferred embodiment, the fire-resistant construction material of the present invention is free of a crack or perforation reaching a back surface thereof after heating combustion at an irradiance intensity of 50 kW/m² for 20 minutes by a cone calorimeter test in conformity to ASTM-E-1354.

A fire-resistant treatment method of the present invention includes using the fire-resistant pressure-sensitive adhesive tape of the present invention.

### Advantageous Effects of Invention

According to one embodiment of the present invention, sufficiently high fire resistance, which meets the accreditation criteria for a fire-proof material under the Building Standard Law to the extent possible, can be imparted to various base materials with ease at low cost. In addition, according to one embodiment of the present invention, a fire-resistant construction material having sufficiently high fire resistance, which meets the accreditation criteria for a fire-proof material under the Building Standard Law to the extent possible, can be provided with ease at low cost.

### BRIEF DESCRIPTION OF DRAWINGS

FIG. 1 is a schematic cross-sectional view illustrating a fire-resistant pressure-sensitive adhesive tape according to a preferred embodiment of the present invention.

FIG. 2 is a schematic cross-sectional view illustrating a fire-resistant pressure-sensitive adhesive tape according to another preferred embodiment of the present invention.

FIG. 3 is a schematic cross-sectional view illustrating a fire-resistant pressure-sensitive adhesive tape according to another preferred embodiment of the present invention.

FIG. 4 is a schematic cross-sectional view illustrating a fire-resistant pressure-sensitive adhesive tape according to another preferred embodiment of the present invention.

FIG. 5 is a schematic view illustrating a surface of one example of a fire-resistant layer partially having an opening.

FIG. 6 is a schematic cross-sectional view illustrating a fire-resistant construction material according to a preferred embodiment of the present invention.

FIG. 7 is a schematic cross-sectional view illustrating a fire-resistant construction material according to another preferred embodiment of the present invention.

FIG. 8 is a schematic cross-sectional view illustrating a fire-resistant construction material according to another preferred embodiment of the present invention.

FIG. 9 is a schematic cross-sectional view illustrating a fire-resistant construction material according to another preferred embodiment of the present invention.

### DESCRIPTION OF EMBODIMENTS

### <<Fire-Resistant Pressure-Sensitive Adhesive Tape>>

A fire-resistant pressure-sensitive adhesive tape of the present invention includes a fire-resistant layer and a pressure-sensitive adhesive layer. The fire-resistant layer and the pressure-sensitive adhesive layer are each preferably disposed as an outermost layer. The number of the fire-resistant layers may be only one, or may be two or more. The number of the pressure-sensitive adhesive layers may be only one, or may be two or more.

The fire-resistant pressure-sensitive adhesive tape of the present invention may include any appropriate other layer between the fire-resistant layer and the pressure-sensitive adhesive layer as long as the effects of the present invention are not impaired. The number of such other layers may be only one, or may be two or more. Such other layer is, for example, an easy adhesion layer. The formation of the easy adhesion layer between the fire-resistant layer and the pressure-sensitive adhesive layer can improve adhesiveness between the fire-resistant layer and the pressure-sensitive adhesive layer, which can contribute to improving the effects of the present invention.

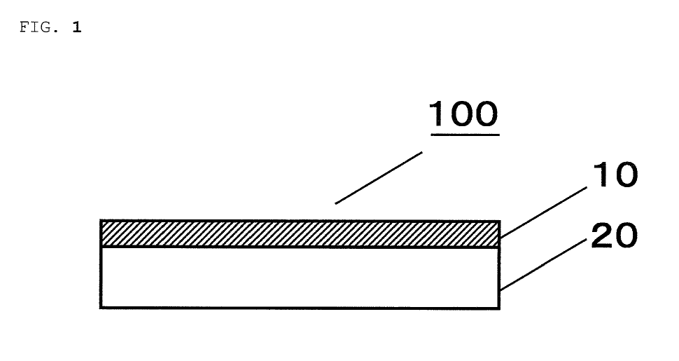

FIG. 1 is a schematic cross-sectional view illustrating a fire-resistant pressure-sensitive adhesive tape according to a preferred embodiment of the present invention. In FIG. 1, a fire-resistant pressure-sensitive adhesive tape 100 of the present invention includes a fire-resistant layer 10 and a pressure-sensitive adhesive layer 20.

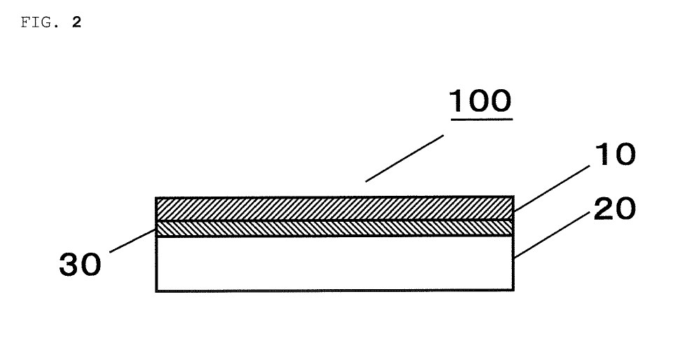

FIG. 2 is a schematic cross-sectional view illustrating a fire-resistant pressure-sensitive adhesive tape according to another preferred embodiment of the present invention. In FIG. 2, the fire-resistant pressure-sensitive adhesive tape 100 of the present invention includes the fire-resistant layer 10 and the pressure-sensitive adhesive layer 20, and includes an easy adhesion layer 30 between the fire-resistant layer 10 and the pressure-sensitive adhesive layer 20.

The fire-resistant pressure-sensitive adhesive tape of the present invention preferably includes a surface protective layer on the side of the fire-resistant layer opposite to the pressure-sensitive adhesive layer. The surface protective layer and the pressure-sensitive adhesive layer are each preferably disposed as an outermost layer. The number of the surface protective layers may be only one, or may be two or more.

In the case where the fire-resistant pressure-sensitive adhesive tape of the present invention includes the surface protective layer on the side of the fire-resistant layer opposite to the pressure-sensitive adhesive layer, the fire-resistant pressure-sensitive adhesive tape may include any appropriate other layer between the surface protective layer and the fire-resistant layer as long as the effects of the present invention are not impaired. The number of such other layers may be only one, or may be two or more. Such other layer is, for example, an easy adhesion layer. The formation of the easy adhesion layer between the surface protective layer and the fire-resistant layer can improve adhesiveness between the layers, which can contribute to improving the effects of the present invention.

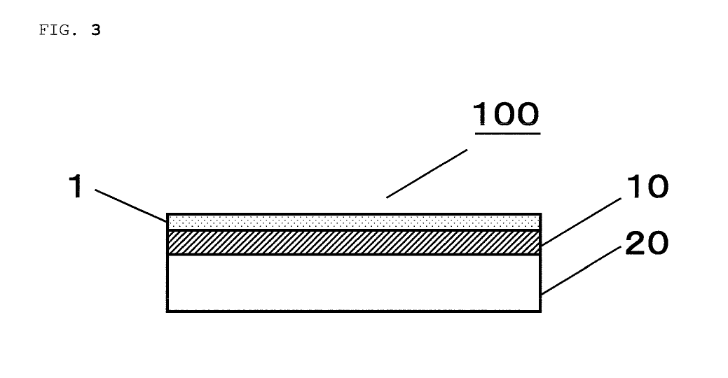

FIG. 3 is a schematic cross-sectional view illustrating a fire-resistant pressure-sensitive adhesive tape according to another preferred embodiment of the present invention. In FIG. 3, the fire-resistant pressure-sensitive adhesive tape 100 of the present invention includes the surface protective layer 1, the fire-resistant layer 10, and the pressure-sensitive adhesive layer 20.

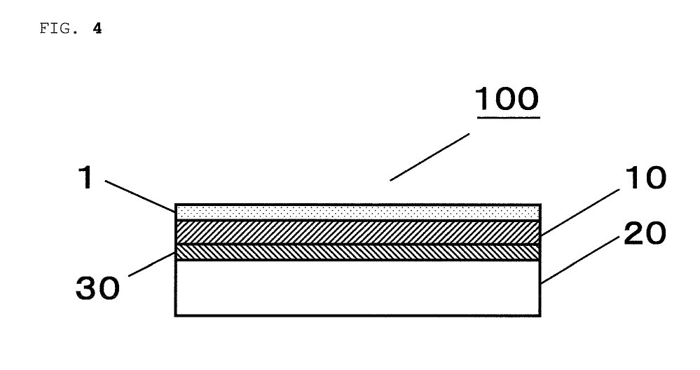

FIG. 4 is a schematic cross-sectional view illustrating a fire-resistant pressure-sensitive adhesive tape according to another preferred embodiment of the present invention. In FIG. 4, the fire-resistant pressure-sensitive adhesive tape 100 of the present invention includes the surface protective layer 1, the fire-resistant layer 10, and the pressure-sensitive adhesive layer 20, and includes the easy adhesion layer 30 between the fire-resistant layer 10 and the pressure-sensitive adhesive layer 20.

In the case where the fire-resistant pressure-sensitive adhesive tape of the present invention includes the surface protective layer on the side of the fire-resistant layer opposite to the pressure-sensitive adhesive layer, in which the surface protective layer is included as an outermost layer, the fire-resistant pressure-sensitive adhesive tape of the present invention has an outermost surface protected with the surface protective layer, and hence can be prevented from, for example, being blocked or damaged and can have high fire resistance.

The surface protective layer has a thickness of preferably from 0.01 μm to 1,000 μm, more preferably from 0.1 μm to 500 μm, still more preferably from 0.2 μm to 400 μm, particularly preferably from 0.5 μm to 300 μm. When the thickness of the surface protective layer is controlled to fall within the range, the fire-resistant pressure-sensitive adhesive tape of the present invention can more sufficiently express surface protective performance and can have high fire resistance.

Any appropriate surface protective layer that may be used in the pressure-sensitive adhesive tape may be adopted as the surface protective layer as long as the effects of the present invention are not impaired. The number of the surface protective layers may be only one, or may be two or more.

The surface protective layer may be formed, for example, by applying a solution or dispersion of a urethane resin, an acrylic resin, a polyester resin, or the like to a surface of the fire-resistant layer, and drying the applied solution or dispersion. Alternatively, the surface protective layer may be formed by applying a coating liquid obtained by compounding a UV-curable oligomer or monomer, which is cured through cross-linking by UV light curing, and a photopolymerization initiator, and subjecting the applied coating liquid to UV light curing. Alternatively, the surface protective layer may be formed by bonding a resin film such as a polyvinyl chloride film, a polyester film, or a polyolefin-based film to a surface of the fire-resistant layer with an adhesive, a pressure-sensitive adhesive, or the like. Alternatively, the surface protective layer may be formed by bonding a nonwoven fabric, a cloth, a glass cloth, or the like to a surface of the fire-resistant layer with an adhesive, a pressure-sensitive adhesive, or the like. Alternatively, the surface protective layer may be formed by bonding a double-coated tape that includes a nonwoven fabric including a release liner on one surface thereof onto the fire-resistant layer.

Preferred examples of the surface protective layer including a resin film as a base include a pressure-sensitive adhesive film including a PET film as a base material, a pressure-sensitive adhesive film including a polyvinyl chloride-based film as a base material, and a pressure-sensitive adhesive film including a polyolefin-based film as a base material. Examples of the polyolefin-based film include a polyethylene-based film, a polypropylene-based film, and a film obtained by mixing polyethylene and polypropylene.

In the case where the surface protective layer includes at least one kind selected from pressure-sensitive adhesive films including a PET film, a polyvinyl chloride-based film, and a polyolefin-based film as base materials, the fire-resistant pressure-sensitive adhesive tape of the present invention can more sufficiently express surface protective performance and can have high fire resistance.

Herein, the surface protective material including a resin film as a base refers to a surface protective material including a resin film such as a polyvinyl chloride-based film or a polyolefin-based film as a base material.

In the fire-resistant pressure-sensitive adhesive tape of the present invention, a composite member obtained by bonding the fire-resistant pressure-sensitive adhesive tape to an adherend having a thickness of from 0.1 mm to 50 mm has a total heat release of preferably 8 MJ/m² or less, more preferably 5 MJ/m² or less, still more preferably 3 MJ/m² or less, particularly preferably 1 MJ/m² or less in heating combustion at an irradiance intensity of 50 kW/m² for 10 minutes by a cone calorimeter test in conformity to ASTM-E-1354 . A value for the lower limit of the total heat release is preferably as small as possible, most preferably 0 MJ/m².

In the fire-resistant pressure-sensitive adhesive tape of the present invention, a composite member obtained by bonding the fire-resistant pressure-sensitive adhesive tape to an adherend having a thickness of from 0.1 mm to 50 mm has a total heat release of preferably 8 MJ/m² or less, more preferably 5 MJ/m² or less, still more preferably 3 MJ/m² or less, particularly preferably 1 MJ/m² or less in heating combustion at an irradiance intensity of 50 kW/m² for 20 minutes by a cone calorimeter test in conformity to ASTM-E-1354 . A value for the lower limit of the total heat release is preferably as small as possible, most preferably 0 MJ/m².

In the fire-resistant pressure-sensitive adhesive tape of the present invention, each of the total heat release in the heating combustion for 10 minutes and the total heat release in the heating combustion for 20 minutes is preferably 8 MJ/m² or less, more preferably 5 MJ/m² or less, still more preferably 3 MJ/m² or less, particularly preferably 1 MJ/m² or less.

In the fire-resistant pressure-sensitive adhesive tape of the present invention, a composite member obtained by bonding the fire-resistant pressure-sensitive adhesive tape to an adherend having a thickness of from 0.1 mm to 50 mm has a time for heat release exceeding 200 kW/m² of preferably less than 10 seconds, more preferably less than 5 seconds, still more preferably less than 3 seconds, particularly preferably less than 1 second in heating combustion at an irradiance intensity of 50 kW/m² for 10 minutes by a cone calorimeter test in conformity to ASTM-E-1354. A value for the lower limit of the time for heat release is preferably as small as possible, most preferably 0 seconds.

In the fire-resistant pressure-sensitive adhesive tape of the present invention, a composite member obtained by bonding the fire-resistant pressure-sensitive adhesive tape to an adherend having a thickness of from 0.1 mm to 50 mm has a time for heat release exceeding 200 kW/m² of preferably less than 10 seconds, more preferably less than 5 seconds, still more preferably less than 3 seconds, particularly preferably less than 1 second in heating combustion at an irradiance intensity of 50 kW/m² for 20 minutes by a cone calorimeter test in conformity to ASTM-E-1354. A value for the lower limit of the time for heat release is preferably as small as possible, most preferably 0 seconds.

In the fire-resistant pressure-sensitive adhesive tape of the present invention, each of the time for heat release exceeding 200 kW/m² in the heating combustion for 10 minutes and the time for heat release exceeding 200 kW/m² in the heating combustion for 20 minutes is preferably less than 10 seconds, more preferably less than 5 seconds, still more preferably less than 3 seconds, particularly preferably less than 1 second.

In the fire-resistant pressure-sensitive adhesive tape of the present invention, a composite member obtained by bonding the fire-resistant pressure-sensitive adhesive tape to an adherend having a thickness of from 0. 1 mm to 50 mm preferably does not disappear, though having such a crack or perforation reaching a back surface, which is detrimental to fire prevention, and is more preferably free of such a crack or perforation reaching a back surface, which is detrimental to fire prevention, after heating combustion at an irradiance intensity of 50 kW/m² for 20 minutes by a cone calorimeter test in conformity to ASTM-E-1354.

Any appropriate adherend may be selected as the adherend having a thickness of from 0. 1 mm to 50 mm. Examples of such adherend include a paper board, a wooden board, a plywood board (veneer board), an MDF board (hollow fiber board), an SPF material (wood deck material), a polycarbonate sheet, a polyolefin sheet, an acrylic resin sheet, a polystyrene sheet, a styrofoam, and a laminate thereof. It should be noted that the “adherend” as used herein can be regarded as the “member” in the fire-resistant construction material of the present invention.

Details about the cone calorimeter test are described later.

In the fire-resistant pressure-sensitive adhesive tape of the present invention, the fire-resistant layer includes aluminum. Preferred examples of such fire-resistant layer include an aluminum foil, a laminate in which an aluminum foil is laminated, and a glass cloth aluminum foil. Examples of the laminate in which an aluminum foil is laminated include: a laminate of an aluminum foil and a polyolefin layer; a laminate of an aluminum foil and a polyester layer; a laminate of an aluminum foil and a nitrocellulose layer; a laminate of an aluminum foil and paper; and a laminate of an aluminum foil and any other metal foil.

The fire-resistant pressure-sensitive adhesive tape of the present invention includes the fire-resistant layer as described above, and hence can impart sufficiently high fire resistance, which meets the accreditation criteria for a fire-proof material under the Building Standard Law to the extent possible, to various base materials with ease at low cost.

The fire-resistant layer has a thickness of preferably from 5 μm to 300 μm.

In the case where the fire-resistant layer is an aluminum foil, the fire-resistant layer has a thickness of more preferably from 5 μm to 200 μm, still more preferably from 5 μm to 100 μm, particularly preferably from 5 μm to 80 μm. In the case where the fire-resistant layer is an aluminum foil, when the thickness of the fire-resistant layer falls within the range, the fire-resistant pressure-sensitive adhesive tape of the present invention can additionally impart sufficiently high fire resistance, which meets the accreditation criteria for a fire-proof material under the Building Standard Law to the extent possible, to various base materials with ease at low cost.

In the case where the fire-resistant layer is a laminate in which an aluminum foil is laminated, the fire-resistant layer has a thickness of more preferably from 10 μm to 200 μm, still more preferably from 30 μm to 170 μm, particularly preferably from 50 μm to 150 μm. In the case where the fire-resistant layer is a laminate in which an aluminum foil is laminated, when the thickness of the fire-resistant layer falls within the range, the fire-resistant pressure-sensitive adhesive tape of the present invention can additionally impart sufficiently high fire resistance, which meets the accreditation criteria for a fire-proof material under the Building Standard Law to the extent possible, to various base materials with ease at low cost.

In the case where the fire-resistant layer is a glass cloth aluminum foil, the fire-resistant layer has a thickness of more preferably from 50 μm to 300 μm, still more preferably from 100 μm to 300 μm, particularly preferably from 150 μm to 300 μm. In the case where the fire-resistant layer is a glass cloth aluminum foil, when the thickness of the fire-resistant layer falls within the range, the fire-resistant pressure-sensitive adhesive tape of the present invention can additionally impart sufficiently high fire resistance, which meets the accreditation criteria for a fire-proof material under the Building Standard Law to the extent possible, to various base materials with ease at low cost.

The fire-resistant layer may partially have an opening. When the fire-resistant layer partially has an opening, the moisture of lumber can be controlled, for example, in the case where the lumber is adopted as an adherend to which the fire-resistant pressure-sensitive adhesive tape of the present invention is bonded to impart fire resistance.

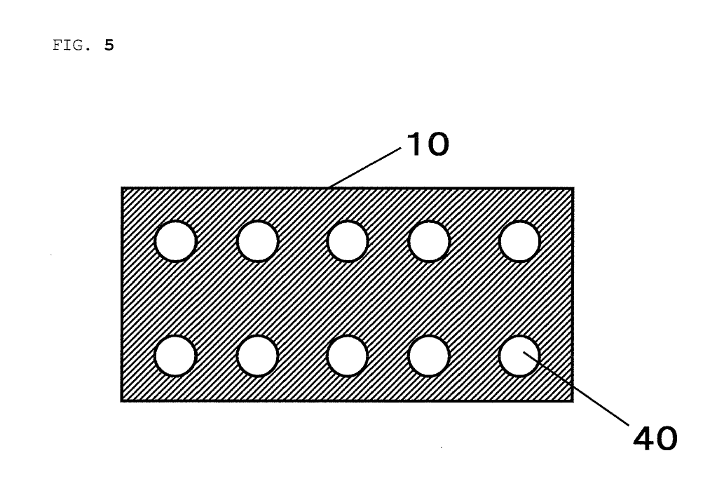

FIG. 5 is a schematic view illustrating one example of a fire-resistant layer surface partially having an opening. In FIG. 5, the fire-resistant layer 10 has a plurality of openings 40. The size and number of the openings 40 may be appropriately selected depending on, for example, the required fire resistance and the moisture control level of lumber. The ratio of the openings in the entire surface (including the openings) of the fire-resistant layer is preferably 10% or less. Any appropriate opening formation method may be selected as a method of forming the openings in the fire-resistant layer.

The thickness of the pressure-sensitive adhesive layer may be appropriately set depending on purposes as long as the effects of the present invention are not impaired. The pressure-sensitive adhesive layer has a thickness of preferably from 5 μm to 2 mm, more preferably from 10 μm to 1.2 mm, still more preferably from 25 μm to 1.0 mm, particularly preferably from 50 μm to 0.8 mm. When the thickness of the pressure-sensitive adhesive layer is controlled to fall within the range, the fire-resistant pressure-sensitive adhesive tape of the present invention can additionally impart sufficiently high fire resistance, which meets the accreditation criteria for a fire-proof material under the Building Standard Law to the extent possible, to various base materials with ease at low cost.

The pressure-sensitive adhesive layer includes a polymer component. The content of the polymer component in the pressure-sensitive adhesive layer is preferably from 20 wt % to 100 wt %, more preferably from 30 wt % to 100 wt %, still more preferably from 40 wt % to 100 wt %, particularly preferably from 50 wt % to 100 wt % with respect to the solid content of the pressure-sensitive adhesive layer. When the content of the polymer component in the pressure-sensitive adhesive layer falls within the range, such an effect that the fire-resistant pressure-sensitive adhesive tape very hardly peels off from an adherend even when exposed to a high-temperature atmosphere such as incase of fire can be expressed.

Any appropriate polymer component may be adopted as the polymer component in the pressure-sensitive adhesive layer as long as the polymer component can express pressure-sensitive adhesive property. The number of kinds of the polymer components in the pressure-sensitive adhesive layer may be only one, or may be two or more. Any appropriate pressure-sensitive adhesive may be selected as such polymer component as long as the effects of the present invention are not impaired.

Examples of the pressure-sensitive adhesive include an acrylic pressure-sensitive adhesive, a rubber-based pressure-sensitive adhesive, a polyester-based pressure-sensitive adhesive, a silicone-based pressure-sensitive adhesive, and a urethane-based pressure-sensitive adhesive. Of those, an acrylic pressure-sensitive adhesive or a rubber-based pressure-sensitive adhesive is preferably given from the viewpoints of, for example, ease of adjustment of a pressure-sensitive adhesive characteristic and low cost, and an acrylic pressure-sensitive adhesive is more preferably given in consideration of stability such as weather resistance.

Any appropriate acrylic polymer that can express pressure-sensitive adhesive property may be adopted as an acrylic polymer. The acrylic polymer may be preferably formed from monomer components essentially including an acrylic monomer. The content of the acrylic monomer in all monomers that may be used for forming the acrylic polymer is preferably 50 wt % to 100 wt % , more preferably 55 wt % to 98 wt o, still more preferably 60 wt % to 95 wt o, particularly preferably 65 wt % to 93 wt %. The acrylic monomers maybe used alone or in combination.

A preferred example of the acrylic monomer is an alkyl(meth)acrylate having an alkyl group. The alkyl(meth)acrylates each having an alkyl group may be used alone or in combination. It should be noted that the term “(meth)acryl” refers to “acryl” and/or “methacryl.”

Examples of the alkyl(meth)acrylate having an alkyl group include an alkyl(meth)acrylate having a linear or branched alkyl group, and an alkyl(meth)acrylate having a cyclic alkyl group. It should be noted that the alkyl(meth)acrylate as used herein means a monofunctional alkyl(meth)acrylate.

Examples of the alkyl(meth)acrylate having a linear or branched alkyl group include alkyl(meth)acrylates each having an alkyl group having 1 to 20 carbon atoms such as methyl(meth)acrylate, ethyl meth(acrylate), propyl(meth)acrylate, isopropyl(meth)acrylate, butyl(meth)acrylate, isobutyl(meth)acrylate, sec-butyl(meth)acrylate, tert-butyl(meth)acrylate, pentyl(meth)acrylate, isopentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, nonadecyl(meth)acrylate, and eicosyl(meth)acrylate. Of those, an alkyl(meth)acrylate having an alkyl group having 2 to 14 carbon atoms is preferred, and an alkyl(meth)acrylate having an alkyl group having 2 to 10 carbon atoms is more preferred.

Examples of the alkyl(meth)acrylate having a cyclic alkyl group include cyclopentyl(meth)acrylate, cyclohexyl (meth)acrylate, and isobornyl(meth)acrylate.

A polyfunctional monomer may be used as a monomer component that can form the acrylic polymer. Any appropriate polyfunctional monomer may be adopted as the polyfunctional monomer. When the polyfunctional monomer is adopted, a cross-linked structure can be imparted to the acrylic polymer. The polyfunctional monomers may be used alone or in combination.

Examples of the polyfunctional monomer include 1,9-nonanediol di(meth)acrylate, 1,6-hexanedioldi(meth)acrylate, 1,4-butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl(meth)acrylate, vinyl(meth)acrylate, divinylbenzene, epoxy acrylate, polyester acrylate, urethane acrylate, 4-hydroxybutyl acrylate glycidyl ether, glycidyl(meth)acrylate, 2-hydroxyethyl(meth)acrylate, 2-hydroxypropyl(meth)acrylate, butanediol(meth)acrylate, 2-hydroxyethyl(meth)acrylate, 4-hydroxybutyl(meth)acrylate, glycidyl ether, 2-isocyanatoethyl acrylate, isocyanatoethyl(meth)acrylate, isocyanato(meth)acrylate, triglycidyl isocyanurate,(meth)acrylic acid, phthalic acid monohydroxyethyl(meth)acrylate, hexahydrophthalic acid monohydroxyethyl(meth)acrylate, 2-hydroxyethyl(meth)acrylate, 2-hydroxypropyl(meth)acrylate, 4-hydroxybutyl(meth)acrylate, dimethyl(meth)acrylamide, diethyl(meth)acrylamide, isopropyl(meth)acrylamide, hydroxyethyl(meth)acrylamide, 1,4-butanediol diglycidyl ether, 1,2-ethanediol diglycidyl ether, polyethylene glycol diglycidyl ether, neopentyl glycol diglycidyl ether, trimethylolpropane polyglycidyl ether, hexamethylene diisocyanate, tolylene diisocyanate, diphenylmethane diisocyanate, triphenylmethane triisocyanate, methyltriisocyanatosilane, tetraisocyanatosilane, polyisocyanate, oxalic acid, malonic acid, succinic acid, glutaric acid, adipic acid, pimelic acid, suberic acid, azelaic acid, sebacic acid, phthalic acid, isophthalic acid, 1,2,3-propanetricarboxylic acid, ethylene glycol, diethylene glycol, propylene glycol, dipropylene glycol, neopentyl glycol, 1,4-butanediol, 1,6-hexanediol, 3-methyl-1,5-pentanediol, 1,2,4-butanetriol, polyoxypropylenetriol, trimethylolethane, trimethylolpropane, aminomethanol, 2-aminoethanol, 3-amino-1-propanol, diethanolamine, triethanolamine, N,N-di-n-butylethanolamine, ethylenediamine, hexamethylenediamine, tolylenediamine, hydrogenated tolylenediamine, diphenylmethanediamine, hydrogenated diphenylmethanediamine, tolidineamine, naphthalenediamine, isophoronediamine, xylenediamine, hydrogenated xylenediamine, vinylamine, 2-(2-thienyl)vinylamine, 1-(allyloxy)vinylamine, allyl alcohol, 1,3-butadiene monoepoxide, and 1-vinyl-3,4-epoxycyclohexane. Of those, from the viewpoint of high reactivity, an acrylate-based polyfunctional monomer is preferred, and 1,9-nonanediol di(meth)acrylate, 1,6-hexanediol di(meth)acrylate, and 4-hydroxybutyl acrylate glycidyl ether are more preferred.

A polar group-containing monomer may be used as a monomer component that can form the acrylic polymer. Any appropriate polar group-containing monomer may be adopted as the polar group-containing monomer. When the polar group-containing monomer is adopted, the cohesive strength of the acrylic polymer can be improved, or the pressure-sensitive adhesive strength of the acrylic polymer can be improved. The polar group-containing monomers may be used alone or in combination.

Examples of the polar group-containing monomer include: carboxyl group-containing monomers such as (meth)acrylic acid, itaconic acid, maleic acid, fumaric acid, crotonic acid, and isocrotonic acid, or anhydrides thereof (for example, maleic anhydride); hydroxy group-containingmonomers such as a hydroxyalkyl(meth)acrylate such as hydroxyethyl(meth)acrylate, hydroxypropyl(meth)acrylate, or hydroxybutyl(meth)acrylate, vinyl alcohol, and allyl alcohol; amide group-containing monomers such as (meth)acrylamide, N,N-dimethyl(meth)acrylamide, N-methylol(meth)acrylamide, N-methoxymethyl(meth)acrylamide, and N-butoxymethyl(meth)acrylamide; amino group-containing monomers such as aminoethyl(meth)acrylate, dimethylaminoethyl(meth)acrylate, and t-butylaminoethyl(meth)acrylate; glycidyl group-containing monomers such as glycidyl(meth)acrylate and methylglycidyl(meth)acrylate; cyano group-containing monomers such as acrylonitrile and methacrylonitrile; heterocycle-containing vinyl-based monomers such as N-vinyl-2-pyrrolidone and (meth)acryloyl morpholine, as well as N-vinylpyridine, N-vinylpiperidone, N-vinylpyrimidine, N-vinylpiperazine, N-vinylpyrrole, N-vinylimidazole, and N-vinyloxazole; alkoxyalkyl(meth)acrylate-based monomers such as methoxyethyl(meth)acrylate and ethoxyethyl(meth)acrylate; sulfonate group-containing monomers such as sodium vinyl sulfonate; phosphate group-containing monomers such as 2-hydroxyethyl acryloyl phosphate; imide group-containing monomers such as cyclohexyl maleimide and isopropyl maleimide; and isocyanate group-containing monomers such as 2-methacryloyloxyethyl isocyanate. The polar group-containing monomer is preferably a carboxyl group-containing monomer or an anhydride thereof, more preferably acrylic acid.

Any other copolymerizable monomer may be used as a monomer component that can form the acrylic polymer. Any appropriate other copolymerizable monomer may be adopted as the other copolymerizable monomer. When the other copolymerizable monomer is adopted, the cohesive strength of the acrylic polymer can be improved, or the pressure-sensitive adhesive strength of the acrylic polymer can be improved. The other copolymerizable monomers may be used alone or in combination.

Examples of the other copolymerizable monomer include: alkyl(meth)acrylates such as a (meth)acrylate having an aromatic hydrocarbon group such as phenyl(meth)acrylate; vinyl esters such as vinyl acetate and vinyl propionate; aromatic vinyl compounds such as styrene and vinyl toluene; olefins or dienes such as ethylene, butadiene, isoprene, and isobutylene; vinyl ethers such as a vinyl alkyl ether; vinyl chloride; alkoxyalkyl(meth)acrylate-based monomers such as methoxyethyl(meth)acrylate and ethoxyethyl(meth)acrylate; sulfonate group-containing monomers such as sodium vinyl sulfonate; phosphate group-containing monomers such as 2-hydroxyethyl acryloyl phosphate; imide group-containing monomers such as cyclohexylmaleimide and isopropylmaleimide; isocyanate group-containing monomers such as 2-methacryloyloxyethyl isocyanate; fluorine atom-containing (meth)acrylates; and silicon atom-containing (meth)acrylates.

The weight-average molecular weight of the acrylic polymer is preferably 300, 000 or more, more preferably 400, 000 to 3, 000, 000. The weight-average molecular weight of the acrylic polymer may be determined by a gel permeation chromatography method (GPC method).

The polymer component in the pressure-sensitive adhesive layer may have a cross-linked structure. When the polymer component in the pressure-sensitive adhesive layer has the cross-linked structure, the pressure-sensitive adhesive layer can express extremely excellent heat resistance.

The cross-linked structure may be constructed by any appropriate method. The cross-linked structure is preferably constructed by incorporating a cross-linking monomer into all monomer components for forming the polymer component. In this case, the content of the cross-linking monomer in all monomer components for forming the polymer component is preferably 2.0 wt % to 60 wt %, more preferably 3.0 wt % to 57 wt %, still more preferably 5.0 wt % to 55 wt %, particularly preferably 7 . 0 wt % to 53 wt %, most preferably 8.0 wt % to 50 wt %. When the content of the cross-linking monomer falls within the range, the pressure-sensitive adhesive layer can express extremely excellent heat resistance to an additional degree.

The number of kinds of the cross-linking monomers may be only one, or may be two or more.

Any appropriate cross-linking monomer may be adopted as the cross-linking monomer as long as the monomer can construct the cross-linked structure. As such cross-linking monomer, there is preferably given a cross-linking monomer having at least one kind of functional group selected from an acryloyl group, an epoxy group, an isocyanate group, a carboxyl group, a hydroxyl group, a vinyl group, and an amino group. Specific examples of such cross-linking monomer include the polyfunctional monomers.

The polymer component in the pressure-sensitive adhesive layer may contain an antioxidant. When the polymer component in the pressure-sensitive adhesive layer contains the antioxidant, the pressure-sensitive adhesive layer can express extremely excellent heat resistance.

The content of the antioxidant in the pressure-sensitive adhesive layer is preferably 0.1 wt % to 10 wt %, more preferably 0.3 wt % to 8 wt %, still more preferably 0.5 wt % to 6 wt %, particularly preferably 0.7 wt % to 5 wt % with respect to the solid content of the pressure-sensitive adhesive layer. When the content of the antioxidant falls within the range, the pressure-sensitive adhesive layer can express extremely excellent heat resistance to an additional degree. The number of kinds of the antioxidants may be only one, or may be two or more.

Any appropriate antioxidant may be adopted as the antioxidant. Such antioxidant is preferably exemplified by at least one kind selected froma phenol-based antioxidant, an amine-based antioxidant, an amino ether-based antioxidant, and a phosphorus-based antioxidant.

Examples of the phenol-based antioxidant may include: monocyclic phenol compounds such as 2,6-di-t-butyl-p-cresol, 2,6-di-t-butyl-4-ethylphenol, 2,6-dicyclohexyl-4-methylphenol, 2,6-diisopropyl-4-ethylphenol, 2,6-di-t-amyl-4-methylphenol, 2,6-di-t-octyl-4-n-propylphenol, 2,6-dicyclohexyl-4-n-octylphenol, 2-isopropyl-4-methyl-6-t-butylphenol, 2-t-butyl-4-ethyl-6-t-octylphenol, 2-isobutyl-4-ethyl-6-t-hexylphenol, 2⁻cyclohexyl⁻4⁻n-butyl-6-isopropylphenol,styrenatedmixedcresol, DL-α-tocopherol, and stearyl β-(3,5-di-t-butyl-4-hydroxyphenyl) propionate; bicyclic phenol compounds such as 2,2′-methylenebis(4-methyl-6-t-butylphenol), 4,4′-butylidenebis(3-methyl-6-t-butylphenol), 4,4′-thiobis(3-methyl-6-t-butylphenol), 2,2′-thiobis(4-methyl-6-t-butylphenol), 4,4′-methylenebis(2,6-di-t-butylphenol), 2,2′-methylenebis[6-(1-methylcyclohexyl)-p-cresol], 2,2′-ethylidenebis(4,6-di-t-butylphenol), 2,2′-butylidenebis(2-t-butyl-4-methylphenol), 3,6-dioxaoctamethylenebis[3-(3-t-butyl-4-hydroxy-5-methylpheny 1)propionate], triethylene glycol-bis[3-(3-t-butyl-5-methyl-4-hydroxyphenyl)propionate], 1,6-hexanediolbis[3-(3,5-di-t-butyl-4-hydroxyphenyl)propionate], and 2,2′-thiodiethylenebis[3-(3,5-di-t-butyl-4-hydroxyphenyl)propionate]; tricyclic phenol compounds such as 1,1,3-tris(2-methyl-4-hydroxy-5-t-butylphenyl)butane, 1,3,5-tris(2,6-dimethyl-3-hydroxy-4-t-butylbenzyl)isocyanurate, 1,3,5-tris[(3,5-di-t-butyl-4-hydroxyphenyl)propionyloxyethyl]isocyanurate, tris(4-t-butyl-2,6-dimethyl-3-hydroxybenzyl)isocyanurate, and 1,3,5-trimethyl-2,4,6-tris(3,5-di-t-butyl-4-hydroxybenzyl)benzene; tetracyclic phenol compounds such as tetrakis[methylene-3-(3,5-di-t-butyl-4-hydroxyphenyl)propionate]methane; and phosphorus-containing phenol compounds such as calcium bis(ethyl 3,5-di-t-butyl-4-hydroxybenzyl phosphonate) and nickel bis(ethyl 3,5-di-t-butyl-4-hydroxybenzyl phosphonate).

Examples of the amine-based antioxidant include bis(2,2,6,6-tetramethyl-4-piperidyl)sebacate, a polycondensate of dimethyl succinate and 1-(2-hydroxyethyl)-4-hydroxy-2,2,6,6-tetramethylpiperidineethanol, N,N′,N″,N′″-tetrakis-(4,6-bis-(butyl-(N-methyl-2,2,6,6-tetra methylpiperidin-4-yl)amino)-triazin-2-yl)-4,7-diazadecane-1,10-diamine, a polycondensate of dibutylamine-1,3,5-triazine-N,N′-bis(2,2,6,6-tetramethyl-4-piperidyl-1,6-hexamethylenediamine) and N-(2,2,6,6-tetramethyl-4-piperidyl)butylamine, poly[{6-(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}], tetrakis(2,2,6,6-tetramethyl-4-piperidyl)-1,2,3,4-butane tetracarboxylate, 2,2,6,6-tetramethyl-4-piperidyl benzoate, bis-(1,2,6,6-pentamethyl-4-piperidyl)-2-(3,5-di-t-butyl-4-hydroxybenzyl)-2-n-butyl malonate, bis-(N-methyl-2,2,6,6-tetramethyl-4-piperidyl)sebacate, 1,1′-(1,2-ethanediyl)bis(3,3,5,5-tetramethylpiperazinone), (mixed 2,2,6,6-tetramethyl-4-piperidyl/tridecyl)-1,2,3,4-butane tetracarboxylate, (mixed 1,2,2,6,6-pentamethyl-4-piperidyl/tridecyl)-1,2,3,4-butane tetracarboxylate, mixed [2,2,6,6-tetramethyl-4-piperidyl/β,β,β′,β′-tetramethyl-3,9-[2,4,8,10-tetraoxaspiro(5.5)undecane]diethyl]-1,2,3,4-butane tetracarboxylate, mixed [1,2,2,6,6-pentamethyl-4-piperidyl/β,β,β′,β′-tetramethyl-3,9-[2,4,8,10-tetraoxaspiro(5.5)undecane]diethyl]-1,2,3,4-butane tetracarboxylate, an N,N′-bis(3-aminopropyl)ethylenediamine-2,4-bis[N-butyl-N-(1,2,2,6,6-pentamethyl-4-piperidyl)amino]-6-chloro-1,3,5-triazine condensate, poly[6-N-morpholyl-1,3,5-triazine-2,4-diyl][(2,2,6,6-tetramethyl-4-piperidyl)imino]hexamethylene[(2,2,6,6-tetramethyl-4-piperidyl)imide], a condensate of N,N′-bis(2,2,6,6-tetramethyl-4-piperidyl)hexamethylenediamine and 1,2-dibromoethane, and N-(2,2,6,6-tetramethyl-4-piperidyl)-2-methyl.

Examples of the amino ether-based antioxidant include bis(2,2,6,6-tetramethyl-4-piperidyl)sebacate, bis(1,2,2,6,6-pentamethyl-4-piperidyl)sebacate, bis(1-methoxy-2,2,6,6-tetramethyl-4-piperidyl)sebacate, bis(1-ethoxy-2,2,6,6-tetramethyl-4-piperidyl)sebacate, bis(1-propoxy-2,2,6,6-tetramethyl-4-piperidyl)sebacate, bis(1-butoxy-2,2,6,6-tetramethyl-4-piperidyl)sebacate, bis(1-pentyloxy-2,2,6,6-tetramethyl-4-piperidyl)sebacate, bis(1-hexyloxy-2,2,6,6-tetramethyl-4-piperidyl)sebacate, bis(1-heptyloxy-2,2,6,6-tetramethyl-4-piperidyl)sebacate, bis(1-octoxy-2,2,6,6-tetramethyl-4-piperidyl)sebacate, bis(1-nonyloxy-2,2,6,6-tetramethyl-4-piperidyl)sebacate, bis(1-decanyloxy-2,2,6,6-tetramethyl-4-piperidyl)sebacate, and bis(1-dodecyloxy-2,2,6,6-tetramethyl-4-piperidyl)sebacate.

Examples of the phosphorus-based antioxidant include triphenylphosphite,diphenylisodecylphosphite,phenyldiisodecyl phosphite, 4,4′-butylidene-bis(3-methyl-6-t-butylphenylditridecyl) phosphite, cyclic neopentanetetraylbis(nonylphenyl)phosphite, cyclic neopentanetetraylbis(dinonylphenyl)phosphite, cyclic neopentane tetrayltris(nonylphenyl)phosphite, cyclic neopentane tetrayltris(dinonylphenyl)phosphite, 10-(2,5-dihydroxyphenyl)-10H-9-oxa-10-phosphaphenanthrene-10-oxide, diisodecyl pentaerythritol diphosphite, and tris(2,4-di-t-butylphenyl)phosphite.

The pressure-sensitive adhesive layer may contain sinterable particles.

The content of the sinterable particles in the pressure-sensitive adhesive layer is preferably 1 wt % to 80 wt %, more preferably 5 wt % to 70 wt %, still more preferably 10 wt % to 60 wt %, particularly preferably 15 wt % to 50 wt % with respect to the solid content of the pressure-sensitive adhesive layer. When the content of the sinterable particles in the pressure-sensitive adhesive layer falls within the range, such an effect that the fire-resistant pressure-sensitive adhesive tape very hardly peels off from an adherend even when exposed to a high-temperature atmosphere such as in case of fire can be sufficiently expressed.

The sinterable particles in the pressure-sensitive adhesive layer preferably include two or more kinds of sinterable particles having different deformation points. When the sinterable particles in the pressure-sensitive adhesive layer include two or more kinds of sinterable particles having different deformation points, the pressure-sensitive adhesive layer can express very excellent heat resistance.

The sinterable particles in the pressure-sensitive adhesive layer each have a deformation point of preferably from 250° C. to 800° C., more preferably from 250° C. to 700° C., still more preferably from 250° C. to 600° C., particularly preferably from 250° C. to 500° C. When the deformation point of each of the sinterable particles in the pressure-sensitive adhesive layer falls within the range, such an effect that the fire-resistant pressure-sensitive adhesive tape very hardly peels off from an adherend even when exposed to a high-temperature atmosphere such as in case of fire can be sufficiently expressed.

Of the two or more kinds of sinterable particles having different deformation points, a sinterable particle having the lowest deformation point has a deformation point of preferably from 250° C. to 800° C., more preferably from 250° C. to 700° C., still more preferably from 250° C. to 600° C., particularly preferably from 250° C. to 500° C. When the deformation point of the sinterable particle having the lowest deformation point falls within the range, the pressure-sensitive adhesive layer can additionally express very excellent heat resistance.

Any appropriate sinterable particles may be adopted as the sinterable particles in the pressure-sensitive adhesive layer. Such sinterable particles are preferably inorganic particles having sintering property, more preferably sinterable particles formed from at least one kind of component selected from silicic acid, boric acid, borosilicic acid, aluminum oxide, calcium oxide, sodium oxide, lithium oxide, and phosphorus oxide. Through the adoption of such sinterable particles, such an effect that the fire-resistant pressure-sensitive adhesive tape very hardly peels off from an adherend even when exposed to a high-temperature atmosphere such as in case of fire can be sufficiently expressed.

The sinterable particles in the pressure-sensitive adhesive layer have an average particle diameter of preferably from 0.1 μm to 1,000 μm, more preferably from 0.5 μm to 500 μm, still more preferably from 1 μm to 300 μm, particularly preferably from 2 μm to 150 μm. When the average particle diameter of the sinterable particles in the pressure-sensitive adhesive layer falls within the range, such an effect that the fire-resistant pressure-sensitive adhesive tape very hardly peels off from an adherend even when exposed to a high-temperature atmosphere such as in case of fire can be sufficiently expressed.

The pressure-sensitive adhesive layer may include any appropriate fine particles as long as the effects of the present invention are not impaired. The number of kinds of such fine particles may be only one, or may be two or more.

Examples of the fine particles that may be contained in the pressure-sensitive adhesive layer may include: particles of a metal such as copper, nickel, aluminum, chromium, iron, or stainless steel and metal oxide particles thereof; particles of a carbide such as silicon carbide, boron carbide, or nitrogen carbide; particles of a nitride such as aluminum nitride, silicon nitride, or boron nitride; particles of a ceramic typified by, for example, alumina or an oxide of zirconium; inorganic particles of calcium carbide, aluminum hydroxide, glass, silica, or the like; particles of a natural material such as volcanic shirasu or sand; and particles of a polymer such as polystyrene, polymethyl methacrylate, a phenol resin, a benzoguanamine resin, a urea resin, a silicone resin, nylon, polyester, polyurethane, polyethylene, polypropylene, polyamide, or polyimide.

Hollow inorganic fine spheres or hollow organic fine spheres may be adopted as the fine particles that may be contained in the pressure-sensitive adhesive layer. Specific examples of the hollow inorganic fine spheres include: hollow balloons made of glass, such as hollow glass balloons; hollow balloons made of metal compounds, such as hollow alumina balloons; and hollow balloons made of ceramics, such as hollow ceramic balloons. Examples of the hollow organic fine spheres include hollow balloons made of resins, such as hollow acrylic balloons and hollow vinylidene chloride balloons.

As commercially available products of the hollow glass balloons, there are given, for example: a product available under the trade name “Glass Microballoon” (from FUJI SILYSIA CHEMICAL LTD.); products available under the trade names “CEL-STAR Z-25,” “CEL-STAR Z-27,” “CEL-STAR CZ-31T,” “CEL-STAR Z-36,” “CEL-STAR Z-39,” “CEL-STAR T⁻36, ” “CEL-STAR SX-39, ” and “CEL-STAR PZ⁻6000” (from Tokai Kougyo Co., Ltd.); and a product available under the trade name “Sai Luxe Fine balloon” (from Fine balloon Ltd.).

Solid glass balloons may be adopted as the fine particles that may be contained in the pressure-sensitive adhesive layer. Commercially available products of the solid glass balloons are, for example: a product available under the trade name “SUNSPHERE NP-100” (from ASAHI GLASS CO., LTD.); and products available under the trade names “Micro Glass Beads EMB-20” and “Glass Beads EGB-210” (from Potters-Ballotini Co., Ltd.). /

Of the fine particles that may be contained in the pressure-sensitive adhesive layer, hollow inorganic fine spheres or hollow organic fine spheres are preferred from the viewpoints of, for example, the efficiency of polymerization with active energy rays (in particular, UV light) and a weight.

A surface of each of the fine particles that may be contained in the pressure-sensitive adhesive layer may be subjected to various surface treatments (e.g., surface tension reducing treatment with a silicone-based compound, a fluorine-based compound, or the like).

The particle diameter (average particle diameter) of the fine particles that may be contained in the pressure-sensitive adhesive layer is not particularly limited, and is, for example, preferably from 1 μm to 500 μm, more preferably 5 μm to 200 um, still more preferably from 10 μm to 100 μm.

Any appropriate specific gravity may be adopted as the specific gravity (true density) of the fine particles that may be contained in the pressure-sensitive adhesive layer as long as the effects of the present invention are not impaired. Such specific gravity is preferably from 0.01 g/cm³ to 1.8 g/cm³, more preferably from 0.02 g/cm³ to 1.5 g/cm³. When the specific gravity of the fine particles that maybe contained in the pressure-sensitive adhesive layer is more than 0.01 g/cm³, the floating of the fine particles hardly occurs, which facilitates the homogeneous dispersion of the fine particles, in compounding the fine particles into the polymer component and mixing the resultant, and the cracking of the fine particles can also be suppressed. When the specific gravity of the fine particles that may be contained in the pressure-sensitive adhesive layer is less than 1.8 g/cm³, there is a small influence on the transmittance of active energy rays (in particular, UV light), that is, the efficiency of a light curing reaction, and the weight of the fire-resistant pressure-sensitive adhesive tape of the present invention does not become too large, leading to satisfactory workability.

Any appropriate compounding amount may be adopted as the compounding amount of the fine particles that may be contained in the pressure-sensitive adhesive layer as long as the effects of the present invention are not impaired. Such compounding amount is preferably from 5 vol % to 50 vol o, more preferably from 10 vol % to 50 vol %, still more preferably from 15 vol % to 40 vol % with respect to the total volume of the pressure-sensitive adhesive layer. When the compounding amount falls within the range, the effects of an adhesive strength and a shear strength at normal temperature are sufficiently exhibited through the addition of the fine particles.

The pressure-sensitive adhesive layer may contain any appropriate other component as long as the effects of the present invention are not impaired. Such other components may be contained alone or in combination.

Examples of the other component include other polymer components, a softening agent, an antioxidant, a curing agent, a plasticizer, a filler, a thermal polymerization initiator, a photopolymerization initiator, a UV absorbing agent, a light stabilizing agent, a coloring agent (e.g., a pigment or a dye), a solvent (organic solvent), a surfactant (e.g., an ionic surfactant, a silicone-based surfactant, or a fluorine-based surfactant), and a cross-linking agent (e.g., a polyisocyanate-based cross-linking agent, a silicone-based cross-linking agent, an epoxy-based cross-linking agent, or an alkyl etherified melamine-based cross-linking agent). It should be noted that the thermal polymerization initiator or the photopolymerization initiator may be contained in a material for forming the polymer component.

Any appropriate thermal polymerization initiator may be adopted as the thermal polymerization initiator. Examples of such thermal polymerization initiator include: peroxide-based polymerization initiators such as hydrogen peroxide, benzoyl peroxide, and t-butyl peroxide; and azo-based polymerization initiators such as 2,2′-azobis-2-methylpropionamidine acid salts, 2,2′-azobis-2,4-dimethylvaleronitrile, 2,2′-azobis-N,N′-dimethyleneisobutylamidine acid salts, 2,2′-azobisisobutyronitrile, and 2,2′-azobis-2-methyl-N-(2-hydroxyethyl)propionamide. The thermal polymerization initiators may be used alone or in combination. Further, such thermal polymerization initiator may be used as a redox-type polymerization initiator by being used in combination with a reducing agent. Examples of such reducing agent include: ionic salts such as a sulfite, a hydrogensulfite, and iron, copper, and cobalt salts; amines such as triethanolamine; and reducing sugars such as an aldose and a ketose.

The content of the thermal polymerization initiator in the pressure-sensitive adhesive layer is preferably 5 parts by weight or less, more preferably 0.01 part by weight to 5 parts by weight, still more preferably 0.05 part by weight to 3 parts by weight with respect to the monomer components to be used for forming the polymer component of the pressure-sensitive adhesive layer.

Any appropriate photopolymerization initiator may be adopted as the photopolymerization initiator. Examples of such photopolymerization initiator include a benzoin ether-based photopolymerization initiator, an acetophenone-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzyl-based photopolymerization initiator, a benzophenone-based photopolymerization initiator, a ketal-based photopolymerization initiator, and a thioxanthone-based photopolymerization initiator. The photopolymerization initiators maybe used alone or in combination.

An example of the ketal-based photopolymerization initiator is 2,2-dimethoxy-1,2-diphenylethan-1-one (such as a product available under the trade name “IRGACURE 651” (from Ciba Speciality Chemicals Inc.)). Examples of the acetophenone-based photopolymerization initiator include 1-hydroxycyclohexyl phenyl ketone (such as a product available under the trade name “IRGACURE 184” (from Ciba Speciality Chemicals Inc.)), 2,2-diethoxyacetophenone, 2,2-dimethoxy-2-phenylacetophenone, 4-phenoxydichloroacetophenone, ₐₙd 4-(t-butyl)dichloroacetophenone. Examples of the benzoin ether-based photopolymerization initiator include benzoin methyl ether, benzoin ethyl ether, benzoin propyl ether, benzoin isopropyl ether, and benzoin isobutyl ether. An example of the acylphosphine oxide-based photopolymerization initiator is a product available under the trade name “Lucirin TPO” (from BASF). Examples of the a-ketol-based photopolymerization initiator include 2-methyl-2-hydroxy propiophenone and 1-[4-(2-hydroxyethyl)phenyl]-2-methylpropan-1-one. An example of the aromatic sulfonyl chloride-based photopolymerization initiator is 2-naphthalenesulfonyl chloride. An example of the photoactive oxime-based photopolymerization initiator is 1⁻phenyl⁻1,1-propanedione-2-(o-ethoxycarbonyl)-oxime. Examples of the benzoin-based photopolymerization initiator include benzoin. An example of the benzyl-based photopolymerization initiator is benzil. Examples of the benzophenone-based photopolymerization initiator include benzophenone, benzoylbenzoic acid, 3,3′-dimethyl-4-methoxybenzophenone, polyvinyl benzophenone, and a-hydroxycyclohexyl phenyl ketone. Examples of the thioxanthone-based photopolymerization initiator include thioxanthone, 2-chlorothioxanthone, 2-methylthioxanthone, 2,4-dimethylthioxanthone, isopropylthioxanthone, 2,4-diisopropylthioxanthone, and dodecylthioxanthone.

The content of the photopolymerization initiator in the pressure-sensitive adhesive layer is preferably 5 parts by weight or less, more preferably 0.01 part by weight to 5 parts by weight, still more preferably 0.05 part by weight to 3 parts by weight with respect to the monomer components to be used for forming the polymer component of the pressure-sensitive adhesive layer.

The pressure-sensitive adhesive layer may be prepared by using as a main agent an acrylic polymer, which is obtained by a commonly-used polymerization method such as a solution polymerization method, an emulsion polymerization method, or a UV polymerization method, and as required, adding thereto various additives such as a cross-linking agent, a tackifier, a softening agent, an antioxidant, a rust preventive such as benzotriazole, and a filler. It shouldbe noted that the pressure-sensitive adhesive layer may be a pressure-sensitive adhesive layer including a resin film, a nonwoven fabric, a cloth, or the like.

The fire-resistant pressure-sensitive adhesive tape of the present invention is a fire-resistant pressure-sensitive adhesive tape including a fire-resistant layer and a pressure-sensitive adhesive layer, and can be bonded to an adherend with a pressure-sensitive adhesive to form the fire-resistant layer on the adherend. Thus, unlike the case where an aluminum foil is bonded using an adhesive, a work environment is good because no solvent is used at the time of application, the fire-resistant layer can be simply formed on the adherend because a time for drying an adhesive is unnecessary, and it is easy to make the thickness of the pressure-sensitive adhesive uniform as compared to the application of an adhesive, leading to excellent designability. In addition, the use of the pressure-sensitive adhesive enables position correction by re-bonding. Further, the pressure-sensitive adhesive is a soft viscoelastic body, and hence can be expected to provide more adhesion reliability for vibration or impact than that in the case of the bonding with an adhesive.

### <<Manufacturing Method for Fire-Resistant Pressure-Sensitive Adhesive Tape>>

The fire-resistant pressure-sensitive adhesive tape of the present invention may be manufactured by any appropriate method. Preferred examples of the manufacturing method for the fire-resistant pressure-sensitive adhesive tape of the present invention include: a manufacturing method involving laminating a fire-resistant layer and a pressure-sensitive adhesive layer; and a manufacturing method involving laminating a formation material for a pressure-sensitive adhesive layer and a fire-resistant layer and then subjecting the laminate to a curing reaction or the like to form a pressure-sensitive adhesive layer. In addition, in the case where the fire-resistant pressure-sensitive adhesive tape of the present invention includes a surface protective layer on the side of the fire-resistant layer opposite to the pressure-sensitive adhesive layer, preferred examples of the manufacturing method for the fire-resistant pressure-sensitive adhesive tape of the present invention include: a manufacturing method involving laminating a surface protective layer, a fire-resistant layer, and a pressure-sensitive adhesive layer; and a manufacturing method involving laminating a formation material for a pressure-sensitive adhesive layer and a fire-resistant layer, then subjecting the laminate to a curing reaction or the like to form a pressure-sensitive adhesive layer, and then laminating a surface protective layer.

An example of the manufacturing method for the pressure-sensitive adhesive layer is a manufacturing method involving applying a polymerizable composition including a monomer component to be used for forming a polymer component and any appropriate other component (e.g., a tackifier or a cross-linking agent) onto any appropriate base material (e.g., a separator), and drying the applied polymerizable composition. As another manufacturing method for the pressure-sensitive adhesive layer, for example, there is given a method involving: partially polymerizing a polymerizable composition including a monomer component to be used for forming a polymer component and any appropriate photopolymerization initiator to prepare a polymerizable syrup; adding, for example, sinterable particles as required to the polymerizable syrup, followed by uniform dispersion of the sinterable particles in the polymerizable syrup; then applying the dispersion onto any appropriate base material (such as a separator); and subjecting the resultant to photopolymerization (curing) by photoirradiation.

Any appropriate conditions may be adopted as conditions for the photoirradiation, such as a light source, irradiation energy, an irradiation method, and an irradiation time.

An active energy ray to be used in the photoirradiation is, for example, an ionizing radiation such as an α-ray, a β-ray, a γ-ray, a neutron beam, or an electron beam, or UV light. Of those, UV light is preferred.

Irradiation with the active energy ray is performed by using, for example, a black-light lamp, a chemical lamp, a high-pressure mercury lamp, or a metal halide lamp.

Heating may be performed in the polymerization. Any appropriate heating method may be adopted as a heating method. Examples of the heating method include a heating method involving using an electrothermal heater and a heating method involving using an electromagnetic wave such as an infrared ray.

The fire-resistant pressure-sensitive adhesive tape of the present invention may be manufactured by laminating a fire-resistant layer on a pressure-sensitive adhesive layer, which is obtained by the manufacturing method as described above, by any appropriate method.

### <<Fire-Resistant Construction Material>>

A fire-resistant construction material of the present invention includes: a member; and the fire-resistant pressure-sensitive adhesive tape of the present invention bonded to at least one surface of the member. The fire-resistant construction material of the present invention has high fire resistance because the fire-resistant pressure-sensitive adhesive tape is bonded to at least one surface of the member. In addition, in the fire-resistant construction material of the present invention, depending on the kind of the member, the fire-resistant pressure-sensitive adhesive tape can express a moisture-proof effect on the member, an antiseptic effect on the member, and a damage prevention effect on the member.

Any appropriate member may be selected as the member in the fire-resistant construction material of the present invention depending on purposes. The member in the fire-resistant construction material of the present invention is preferably a combustible member. Such combustible member is preferably at least one kind selected from paper, a lumber board, and a resin board.

Any appropriate thickness may be adopted as the thickness of the member in the fire-resistant construction material of the present invention depending on purposes. The thickness of the member in the fire-resistant construction material of the present invention is preferably from 0.1 mm to 50 mm.

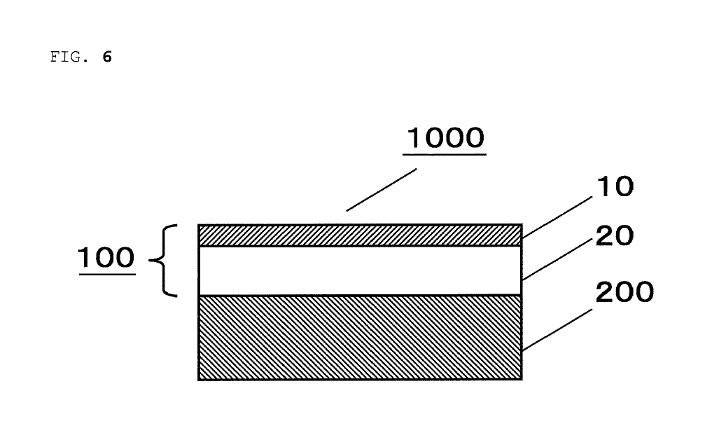

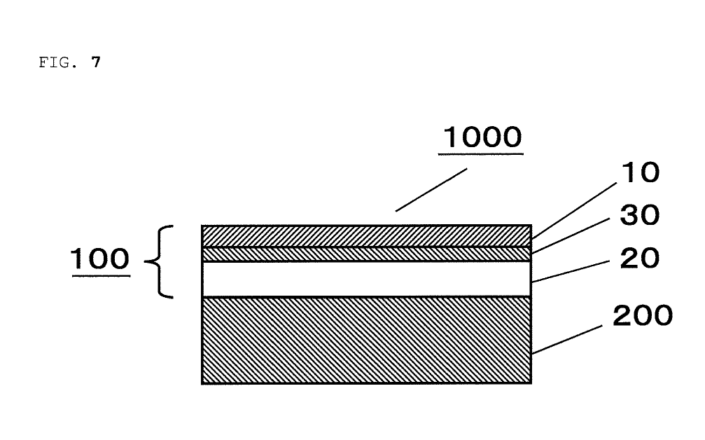

FIG. 6 is a schematic cross-sectional view illustrating a fire-resistant construction material according to a preferred embodiment of the present invention. In FIG. 6, a fire-resistant construction material 1000 of the present invention includes the fire-resistant pressure-sensitive adhesive tape 100 and a member 200. The fire-resistant pressure-sensitive adhesive tape 100 includes the fire-resistant layer 10 and the pressure-sensitive adhesive layer 20. FIG. 7 is a schematic cross-sectional view illustrating a fire-resistant construction material according to another preferred embodiment of the present invention. In FIG. 7, the fire-resistant construction material 1000 of the present invention includes the fire-resistant pressure-sensitive adhesive tape 100 and the member 200. The fire-resistant pressure-sensitive adhesive tape 100 includes the fire-resistant layer 10 and the pressure-sensitive adhesive layer 20, and includes the easy adhesion layer 30 between the fire-resistant layer 10 and the pressure-sensitive adhesive layer 20.

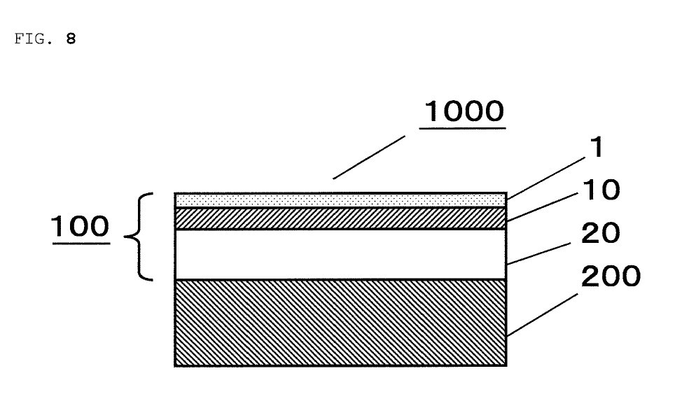

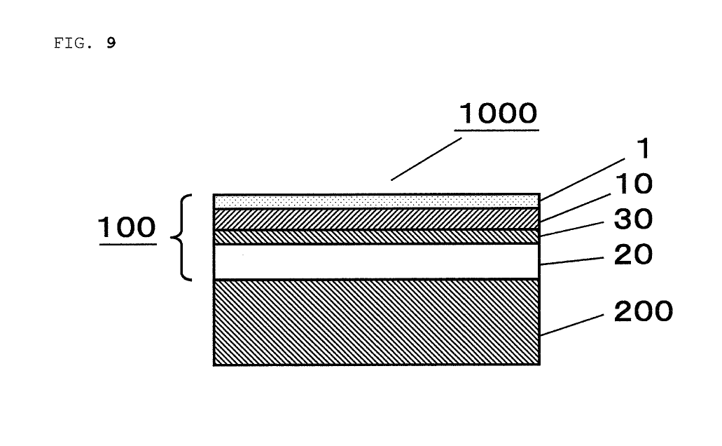

FIG. 8 is a schematic cross-sectional view illustrating a fire-resistant construction material according to another preferred embodiment of the present invention. In FIG. 8, the fire-resistant construction material 1000 of the present invention includes the fire-resistant pressure-sensitive adhesive tape 100 and the member 200. The fire-resistant pressure-sensitive adhesive tape 100 includes the surface protective layer 1, the fire-resistant layer 10, and the pressure-sensitive adhesive layer 20. FIG. 9 is a schematic cross-sectional view illustrating a fire-resistant construction material according to another preferred embodiment of the present invention. In FIG. 9, the fire-resistant construction material 1000 of the present invention includes the fire-resistant pressure-sensitive adhesive tape 100 and the member 200. The fire-resistant pressure-sensitive adhesive tape 100 includes the surface protective layer 1, the fire-resistant layer 10, and the pressure-sensitive adhesive layer 20, and includes the easy adhesion layer 30 between the fire-resistant layer 10 and the pressure-sensitive adhesive layer 20.

The fire-resistant construction material of the present invention has a total heat release of preferably 8 MJ/m² or less, more preferably 5 MJ/m² or less, still more preferably 3 MJ/m² or less, particularly preferably 1 MJ/m² or less in heating combustion at an irradiance intensity of 50 kW/m² for 10 minutes by a cone calorimeter test in conformity to ASTM-E-1354. A value for the lower limit of the total heat release is preferably as small as possible, most preferably 0 MJ/m².

The fire-resistant construction material of the present invention has a total heat release of preferably 8 MJ/m² or less, more preferably 5 MJ/m² or less, still more preferably 3 MJ/m² or less, particularly preferably 1 MJ/m² or less in heating combustion at an irradiance intensity of 50 kW/m² for 20 minutes by a cone calorimeter test in conformity to ASTM-E-1354. A value for the lower limit of the total heat release is preferably as small as possible, most preferably 0 MJ/m².

In the fire-resistant construction material of the present invention, each of the total heat release in the heating combustion for 10 minutes and the total heat release in the heating combustion for 20 minutes is preferably 8 MJ/m² or less, more preferably 5 MJ/m² or less, still more preferably 3 MJ/m² or less, particularly preferably 1 MJ/m² or less.

The fire-resistant construction material of the present invention has a time for heat release exceeding 200 kW/m² of preferably less than 10 seconds, more preferably less than 5 seconds, still more preferably less than 3 seconds, particularly preferably less than 1 second in heating combustion at an irradiance intensity of 50 kW/m² for 10 minutes by a cone calorimeter test in conformity to ASTM-E-1354. A value for the lower limit of the time for heat release is preferably as small as possible, most preferably 0 seconds.

The fire-resistant construction material of the present invention has a time for heat release exceeding 200 kW/m² of preferably less than 10 seconds, more preferably less than 5 seconds, still more preferably less than 3 seconds, particularly preferably less than 1 second in heating combustion at an irradiance intensity of 50 kW/m² for 20 minutes by a cone calorimeter test in conformity to ASTM-E-1354. A value for the lower limit of the time for heat release is preferably as small as possible, most preferably 0 seconds.

In the fire-resistant construction material of the present invention, each of the time for heat release exceeding 200 kW/m² in the heating combustion for 10 minutes and the time for heat release exceeding 200 kW/m² in the heating combustion for 20 minutes is preferably less than 10 seconds, more preferably less than 5 seconds, still more preferably less than 3 seconds, particularly preferably less than 1 second.

The fire-resistant construction material of the present invention preferably does not disappear, though having such a crack reaching a back surface or perforation, which is detrimental to fire prevention, and is more preferably free of such a crack or perforation reaching a back surface, which is detrimental to fire prevention, after heating combustion at an irradiance intensity of 50 kW/m² for 20 minutes by a cone calorimeter test in conformity to ASTM-E-1354.

Details about the cone calorimeter test are described later.

### <<Manufacturing Method for Fire-Resistant Construction Material>>

The fire-resistant construction material of the present invention may be manufactured by any appropriate method. The fire-resistant construction material of the present invention is manufactured, for example, by bonding the fire-resistant pressure-sensitive adhesive tape of the present invention to a member by any appropriate method.

### <<Fire-Resistant Treatment Method>>

Through the use of the fire-resistant pressure-sensitive adhesive tape of the present invention, various base materials such as paper, a lumber board, and a resin board, which are adopted in construction materials required to have fire resistance such as a ceiling material for buildings, a floor material for buildings, a wall surface material for buildings, a ceiling material for railway vehicles, a floor material for railway vehicles, a wall surface material for railway vehicles, an interior material for aircraft, and a material for ships (e.g., a fire-proof partition), can be made non-combustible to improve fire resistance. That is, a fire-resistant treatment method of the present invention is performedusingthefire-resistantpressure-sensitiveadhesivetape of the present invention.

According to the fire-resistant treatment method of the present invention, sufficiently high fire resistance, which meets the accreditation criteria for a fire-proof material in the Building Standard Law to the extent possible, can be imparted to various base materials such as paper, a lumber board, and a resin board with ease at low cost. The fire-resistant treatment method of the present invention is particularly effective for a combustible base material.

### EXAMPLES

Hereinafter, the present invention is described in more detail by way of Examples, but the present invention is not limited to Examples shown below.

It should be noted that a biaxially stretched polyethylene terephthalate film having a thickness of 38 μm (trade name: “MRN38,” manufactured by Mitsubishi Chemical Polyester Film) one surface of which had been subjected to a silicone-based release treatment was used as each of separators and cover separators used in the following respective examples.

### Synthesis Example 1

### Preparation of Photopolymerizable Syrup (A)

90 Parts by weight of 2-ethylhexyl acrylate and 10 parts by weight of acrylic acid as monomer components, 0.05 part by weight of a photopolymerization initiator (trade name: “IRGACURE 651,” manufactured by BASF), and 0.05 part by weight of a photopolymerization initiator (trade name: “IRGACURE 184,” manufactured by BASF) were stirred in a four-necked separable flask equipped with a stirring machine, a temperature gauge, a nitrogen gas-introducing tube, and a cooling tube until the mixture became uniform. After that, bubbling was performed with a nitrogen gas for 1 hour to remove dissolved oxygen. After that, UV light was applied from the outside of the flask by using a black-light lamp to perform polymerization. At the time point when a moderate viscosity was obtained, the lamp was turned off and the blowing of nitrogen was stopped. Thus, a photopolymerizable syrup (A) as a partially polymerized composition having a rate of polymerization of 3.5% was prepared.

### Synthesis Example 2

### (Production of Pressure-Sensitive Adhesive Composition (A)

A polymerization vessel was fed with 95 parts by weight of n-butyl acrylate, 5 parts by weight of acrylic acid, and 150 parts by weight of toluene, and subjected to nitrogen replacement at room temperature for 1 hour. After that, the temperature was increased to 60° C., 0.2 part by weight of 2,2′-azobisisobutyronitrile as a polymerization initiator was added, andpolymerization was performed at 63° C. for 7 hours to provide a copolymer solution of an acrylic polymer having a weight-average molecular weight of 500,000. To the copolymer solution were added 30 parts by weight of a xylene formaldehyde-based tackifier resin having a hydroxy group (trade name “NIKANOL H-80, ” manufactured by MITSUBISHI GAS CHEMICAL COMPANY, INC.) as a tackifier resin, 0.05 part by weight of a nitrogen atom-containing hydroxy compound (trade name “EDP-300,” manufactured by ADEKA CORPORATION, a polyhydroxyalkylamine-based compound) as a hydroxy compound, and 4 parts by weight of an isocyanate compound (trade name “CORONATE L,” manufactured by Nippon Polyurethane Industry Co. , Ltd.) with respect to 100 parts by weight of the solid content of the copolymer, and the contents were mixed well to provide a pressure-sensitive adhesive composition (A) (solid content: 400).

### Synthesis Example 3

### Production of Pressure-Sensitive Adhesive Layer (A)

To 100 parts by weight of an acrylic polymer (acrylic polymer obtained by polymerizing 2-ethylhexyl acrylate, butyl acrylate, and acrylic acid used at a ratio of 70 parts by weight:30 parts by weight:2 parts by weight), 30 parts by weight of a polymerized rosin-based resin (trade name “PENSEL D125,” manufactured by Arakawa Chemical Industries, Ltd.) were added, and 2 parts by weight of an isocyanate-based cross-linking agent (trade name “CORONATE L,” manufactured by Nippon Polyurethane Industry Co., Ltd.) were further added to prepare a pressure-sensitive adhesive composition.

The prepared pressure-sensitive adhesive composition was applied to the release-treated surface of a separator and dried to provide a pressure-sensitive adhesive layer (A) having a thickness of 50 μm, which was formed on the separator.

### Synthesis Example 4

### Production of Pressure-Sensitive Adhesive Layer (B)

To 100 parts by weight of the photopolymerizable syrup (A) obtained in Synthesis Example 1 were added 0.1 part by weight of 1,6-hexanediol diacrylate (HDDA) and 50 parts by weight of a phosphoric acid-based frit (manufactured by TAKARA STANDARD CO., LTD., VY0144, deformation point: 397° C., average particle diameter: 10 μm), and the mixture was homogeneously dispersed with a disper to provide a frit dispersion syrup. The resultant frit dispersion syrup was applied onto the release-treated surface of a separator so that the thickness after curing became 150 μm. A cover separator was attached onto the application surface so that its release-treated surface was brought into contact with the application surface. Next, the frit dispersion syrup was cured by irradiation with UV light at an illuminance of 5 mW/cm² for 5 minutes using a black light lamp (“Black Light,” manufactured by TOSHIBA CORPORATION) as a light source. After that, the cover separator was peeled off to provide a pressure-sensitive adhesive layer (B) having a thickness of 150 μm, one surface of which was covered with the separator.

### Synthesis Example 5

### Production of Pressure-Sensitive Adhesive Layer (C)

To 100 parts by weight of the photopolymerizable syrup (A) obtained in Synthesis Example 1 was added 0.08 part by weight of 1, 6-hexanediol diacrylate (HDDA). After that, 12.5 parts by weight of hollow glass balloons (average particle diameter: 40 μm, trade name “Fuji Balloon H-40,” manufactured by FUJI SILYSIA CHEMICAL LTD.) were added, and 0.04 part by weight of a photopolymerization initiator (trade name “IRGACURE 651,” manufactured by BASF) was further added, with respect to 100 parts by weight of the photopolymerizable syrup (A), to provide a pressure-sensitive adhesive composition containing hollow inorganic fine particles. The pressure-sensitive adhesive composition was applied to the release-treated surface of a separator. A cover separator was attached onto the application surface so that its release-treated surface was brought into contact with the application surface. Next, the pressure-sensitive adhesive composition was curedby irradiation with UV light at an illuminance of 5 mW/cm² from both sides for 3 minutes using a black light lamp (“Black Light,” manufactured by TOSHIBA CORPORATION) as a light source. After that, the cover separator was peeled off to provide a pressure-sensitive adhesive layer (C) having a thickness of 1,200 μm, one surface of which was covered with the separator.

### Synthesis Example 6

### Production of Pressure-Sensitive Adhesive Layer (D)

A silicone-based releasing agent was applied to each of both surfaces of high-quality paper (glassine paper, density: 70 g/m², thickness: 130 μm), both the surfaces having been subjected to lamination treatment with polyethylene, to produce a release liner (sometimes referred to as “release liner A”). The pressure-sensitive adhesive composition (A) obtained in Synthesis Example 2 was applied to one surface of the release liner A so that the thickness after drying became 80 μm, and dried at a temperature of 110° C. for 3 minutes to form a pressure-sensitive adhesive layer D1. Thus, the release liner A having formed thereon the pressure-sensitive adhesive layer D1 was produced. The release liner A having formed thereon the pressure-sensitive adhesive layer D1 was laminated on and attached to one surface side of a rayon pulp nonwoven fabric (trade name “MR Base Paper (basis weight: 14 g/m²),” manufactured by Miki Tokushu Paper MFG. CO., LTD.) in such a manner that the pressure-sensitive adhesive layer D1 was brought into contact with the rayon pulp nonwoven fabric. Thus, a pressure-sensitive adhesive layer A with a nonwoven fabric was obtained.

The pressure-sensitive adhesive composition (A) obtained in Synthesis Example 2 was applied to one surface of another release liner (sometimes referred to as “release liner B”) having the same construction as that of the release liner A so that the thickness after drying became 80 μm, and dried at a temperature of 110° C. for 3 minutes to form a pressure-sensitive adhesive layer D2. Thus, the release liner B having formed thereon the pressure-sensitive adhesive layer D2 was produced. The release liner B having formed thereon the pressure-sensitive adhesive layer D2 was laminated and attached in such a manner that the nonwoven fabric surface of the pressure-sensitive adhesive layer A with a nonwoven fabric was brought into contact with the pressure-sensitive adhesive layer D2. After that, the release liner B was peeled off to produce a pressure-sensitive adhesive layer (D) having a thickness of 160 μm, one surface of which was covered with the release liner A having a thickness of 130 μm.

### Example 1

The pressure-sensitive adhesive layer (A) having a separator on one surface thereof obtained in Synthesis Example 3 was bonded onto an aluminum sheet (thickness: 50 μm) with a hand roller. Next, the separator was peeled off to produce a pressure-sensitive adhesive sheet having an aluminum base material (1) having a thickness of 100 μm.

### Example 2

The pressure-sensitive adhesive layer (D), on one surface of which was covered with the release liner A, obtained in Synthesis Example 6 was bonded onto an aluminum sheet (thickness: 12 μm) with a hand roller. Next, the release liner A was peeled off to produce a pressure-sensitive adhesive sheet having an aluminum base material (2) having a thickness of 172 μm.

### Example 3

The pressure-sensitive adhesive layer (B) having a separator on one surface thereof obtained in Synthesis Example 4 was bonded onto an aluminum sheet (thickness: 12 μm) with a hand roller. Next, the separator was peeled off to produce a pressure-sensitive adhesive sheet having an aluminum base material (3) having a thickness of 162 μm.

### Example 4

The pressure-sensitive adhesive layer (C) having a separator on one surface thereof obtained in Synthesis Example 5 was bonded onto an aluminum sheet (thickness: 12 μm) with a hand roller. Next, the separator was peeled off to produce a pressure-sensitive adhesive sheet having an aluminum base material (4) having a thickness of 1,212 μm.

### Example 5

The pressure-sensitive adhesive sheet having the aluminum base material (1) obtained in Example 1 was bonded onto a veneer board (thickness: 2.3 mm) with a hand roller to provide a composite member (1). The composite member (1) was subjected to evaluations.

### Example 6

The pressure-sensitive adhesive sheet having the aluminum base material (1) obtained in Example 1 was bonded onto a veneer board (thickness: 5.5 mm) with a hand roller to provide a composite member (2). The composite member (2) was subjected to evaluations.

### Example 7

The pressure-sensitive adhesive sheet having the aluminumbase material (1) obtained in Example 1 was bonded onto a medium-density fiber board (MDF board) (thickness: 9 mm) with a hand roller to provide a composite member (3). The composite member (3) was subjected to evaluations.

### Example 8

The pressure-sensitive adhesive sheet having the aluminumbase material (1) obtained in Example 1 was bonded onto a polycarbonate board (thickness: 2 mm, trade name “PC1600, ” manufactured by Takiron Co., Ltd.) with a hand roller to provide a composite member (4). The composite member (4) was subjected to evaluations.

### Example 9

The pressure-sensitive adhesive sheet having the aluminumbase material (1) obtained in Example 1 was bonded onto a polycarbonate sheet (thickness: 0.5 mm, trade name “POLICAACE ECG101S,” manufactured by Sumitomo Bakelite, Co., Ltd.) with a hand roller to provide a composite member (5). The composite member (5) was subjected to evaluations.

### Example 10

The pressure-sensitive adhesive sheet having the aluminumbase material (1) obtained in Example 1 was bonded onto a polypropylene board (thickness: 2 nun, trade name “KOBE POLYSHEET POLYPROPYLENE BOARD PP-N-AN, ” manufactured by Shin-Kobe Electric Machinery, Co., Ltd.) with a hand roller to provide a composite member (6). The composite member (6) was subjected to evaluations.

### Example 11

The pressure-sensitive adhesive sheet having the aluminumbase material (1) obtained in Example 1 was bonded onto an acrylic board (thickness: 2 mm, trade name “ACRYLITE 001,” manufactured by Mitsubishi Rayon Co. , Ltd.) with a hand roller to provide a composite member (7). The composite member (7) was subjected to evaluations.

### Example 12

The pressure-sensitive adhesive sheet having the aluminumbase material (1) obtained in Example 1 was bonded onto an SPF material (thickness: 19 mm) with a hand roller to provide a composite member (8). The composite member (8) was subjected to evaluations.

### Example 13

The pressure-sensitive adhesive sheet having the aluminum base material (1) obtained in Example 1 was bonded onto an SPF material (thickness: 38 mm) with a hand roller to provide a composite member (9). The composite member (9) was subjected to evaluations.

### Example 14

The pressure-sensitive adhesive sheet having the aluminum base material (2) obtained in Example 2 was bonded onto a veneer board (thickness: 2.3 mm) with a hand roller to provide a composite member (10). The composite member (10) was subjected to evaluations.

### Example 15

The pressure-sensitive adhesive sheet having the aluminum base material (3) obtained in Example 3 was bonded onto a veneer board (thickness: 2.3 mm) with a hand roller to provide a composite member (11). The composite member (11) was subjected to evaluations.

### Example 16

The pressure-sensitive adhesive sheet having the aluminum base material (4) obtained in Example 4 was bonded onto a veneer board (thickness: 2.3 mm) with a hand roller to provide a composite member (12). The composite member (12) was subjected to evaluations.

### Example 17

Two pressure-sensitive adhesive sheets having the aluminum base material (thickness: 110 μm, width: 50 mm, trade name “Aluminum Kraft Tape J 3200,” manufactured by Nitoms, Inc.) were bonded onto a veneer board (thickness: 2.3 mm) with a hand roller without providing any gap to provide a composite member (13). The composite member (13) was subjected to evaluations.

### Example 18

Two pressure-sensitive adhesive sheets having the aluminum base material (thickness: 110μm, width: 50 mm, trade name “Aluminum Kraft Tape J 3200,” manufactured by Nitoms, Inc.) were bonded onto a veneer board (thickness: 5.5 mm) with a hand roller without providing any gap to provide a composite member (14). The composite member (14) was subjected to evaluations.

### Example 19

A pin support (trade name “Senkichi Kenzan Daikaku No. 14,” manufactured by Fujiwara Sangyo Co., Ltd.) was pressed against the pressure-sensitive adhesive sheet having the aluminum base material (1) obtained in Example 1 to form openings each having a diameter of 0.4 mm at intervals of 3.5 mm. Thus, an aluminum base material pressure-sensitive adhesive sheet having openings was obtained. The aluminum base material pressure-sensitive adhesive sheet having openings was bonded onto a veneer board (thickness: 2.3 mm) with a hand roller to provide a composite member (15). The composite member (15) was subjected to evaluations.

### Example 20

A pin support (trade name “Senkichi Kenzan Daikaku No. 14,” manufactured by Fujiwara Sangyo Co., Ltd.) was pressed against the pressure-sensitive adhesive sheet having the aluminum base material (1) obtained in Example 1 to form openings each having a diameter of 0.4 mm at intervals of 3.5 mm. Thus, an aluminum base material pressure-sensitive adhesive sheet having openings was obtained. The aluminum base material pressure-sensitive adhesive sheet having openings was bonded onto a veneer board (thickness: 5.5 mm) with a hand roller to provide a composite member (16). The composite member (16) was subjected to evaluations.

### Comparative Example 1

A veneer board (thickness: 2.3 mm) alone was subjected to evaluations.

### Comparative Example 2

A veneer board (thickness: 5.5 mm) alone was subjected to evaluations.

### Comparative Example 3

An MDF board (thickness: 9 mm) alone was subjected to evaluations.

### Comparative Example 4

A polycarbonate board (thickness: 2 mm, trade name “PC1600,” manufactured by Takiron Co., Ltd.) alone was subjected to evaluations.

### Comparative Example 5

Apolycarbonate sheet (thickness: 0. 5 mm, trade name “POLICAACE ECG101S,” manufactured by Sumitomo Bakelite, Co., Ltd.) alone was subjected to evaluations.

### Comparative Example 6

A polypropylene board (thickness: 2 mm, trade name “KOBE POLYSHEET POLYPROPYLENE BOARD PP-N-AN,” manufactured by Shin-Kobe Electric Machinery, Co., Ltd.) alone was subjected to evaluations.

### Comparative Example 7

An acrylic board (thickness: 2 mm, trade name “ACRYLITE 001,” manufactured by Mitsubishi Rayon Co., Ltd.) alone was subjected to evaluations.

### Comparative Example 8

The pressure-sensitive adhesive layer (A) obtained in Synthesis Example 3 was bonded to the PET surface of aluminum-deposited PET (thickness: 25pm, trade name “Metalumy 25S,” manufactured by Toray Industries, Inc.) with a hand roller. Next, a separator was peeled off to provide an aluminum base material pressure-sensitive adhesive sheet (5) having a thickness of 88 μm. The pressure-sensitive adhesive sheet having the aluminum base material (5) was bonded onto a veneer board (thickness: 2.3 mm) with a hand roller to provide a composite member (C1) having an aluminum-deposited layer on a surface thereof. The composite member (C1) was subjected to evaluations.

### Comparative Example 9

An SPF material (thickness: 19 mm) alone was subjected to evaluations.

### Comparative Example 10

An SPF material (thickness: 38 mm) alone was subjected to evaluations.

### [Total Heat Release and Time for Heat Release by Cone Calorimeter Test]

A test piece having a planar square shape 99 mm on a side was cut out of an object to be evaluated (each of the composite members obtained in Examples and various members prepared in Comparative Examples). The test piece was irradiated with heat rays at 50 kW/m² using a cone calorimeter in conformity to a combustion test (ASTM E1354) to combust the test piece. A total heat release (MJ/m²) and a time for heat release exceeding 200 kW/m² (seconds) at each of an elapsed time of 10 minutes and an elapsed time of 20 minutes in the heating combustion of the test piece for 20 minutes were measured.
(Assessment Criteria)
(1) Total Heat Release
⊚: A total heat release of 8 MJ/m² or less in a period of 20 minutes.
∘: A total heat release of more than 8 MJ/m² in a period of 20 minutes and a total heat release of 8 MJ/m² or less in a period of 10 minutes.
×: A total heat release of more than 8 MJ/m² in a period of 10 minutes.
(2) Time for Heat Release Exceeding 200 kW/m²
⊚: A time for heat release exceeding 200 kW/m² (seconds) of less than 10 seconds in a period of 20 minutes.
∘: A time for heat release exceeding 200 kW/m² (seconds) of 10 seconds or more in a period of 20 minutes and a time for heat release exceeding 200 kW/m² (seconds) of less than 10 seconds in a period of 10 minutes.
×: A time for heat release exceeding 200 kW/m² (seconds) of 10 seconds or more in a period of 10 minutes.
(3) Crack/Perforation
∘: Absence of a crack or perforation detrimental to fire prevention.
Δ: Presence of a crack or perforation detrimental to fire prevention.
×x: Disappearance.

TABLE 1

| | | | | Time for heat | | | |
|---|---|---|---|---|---|---|---|
| | Total heat | | | release exceeding | | | |
| | release (MJ/m²) | | | 200 kW/m² (seconds) | | | Crack/ |
| | 10 minutes | 20 minutes | Assessment | 10 minutes | 20 minutes | Assessment | perforation |
| Example 5 | 0.1 | 0.1 | ⊚ | 0 | 0 | ⊚ | ◯ |
| Example 6 | 0.1 | 2.5 | ⊚ | 0 | 0 | ⊚ | ◯ |
| Example 7 | 0.0 | 0.0 | ⊚ | 0 | 0 | ⊚ | ◯ |
| Example 8 | 0.3 | 1.2 | ⊚ | 0 | 0 | ⊚ | ◯ |
| Example 9 | 0.2 | 0.2 | ⊚ | 0 | 0 | ⊚ | ◯ |
| Example 10 | 0.3 | 0.9 | ⊚ | 0 | 0 | ⊚ | ◯ |
| Example 11 | 0.0 | 26.0 | ◯ | 0 | 0 | ⊚ | Δ |
| Example 12 | 0.0 | 0.0 | ⊚ | 0 | 0 | ⊚ | ◯ |
| Example 13 | 0.5 | 1.8 | ⊚ | 0 | 0 | ⊚ | ◯ |
| Example 14 | 0.3 | 5.1 | ◯ | 0 | 0 | ⊚ | ◯ |
| Example 15 | 0.1 | 0.4 | ⊚ | 0 | 0 | ⊚ | ◯ |
| Example 16 | 0.4 | 23.3 | ⊚ | 0 | 0 | ⊚ | Δ |
| Example 17 | 2.2 | 11.0 | ◯ | 0 | 0 | ⊚ | ◯ |
| Example 18 | 0.1 | 21.3 | ◯ | 0 | 75 | ◯ | Δ |
| Example 19 | 0.1 | 14.4 | ◯ | 0 | 18 | ◯ | Δ |
| Example 20 | 0.0 | 32.8 | ◯ | 0 | 0 | ⊚ | Δ |
| Comparative | 24.0 | 24.5 | X | 31 | 31 | X | X |
| Example 1 | | | | | | | |
| Comparative | 39.4 | 51.5 | X | 0 | 0 | X | X |
| Example 2 | | | | | | | |
| Comparative | 59.9 | 80.7 | X | 40 | 40 | X | X |
| Example 3 | | | | | | | |
| Comparative | 49.1 | 55.0 | X | 72 | 72 | X | X |
| Example 4 | | | | | | | |
| Comparative | 13.5 | 13.6 | X | 18 | 18 | X | X |
| Example 5 | | | | | | | |
| Comparative | 34.2 | 35.8 | X | 57 | 57 | X | X |
| Example 6 | | | | | | | |
| Comparative | 59.9 | 60.3 | X | 97 | 97 | X | X |
| Example 7 | | | | | | | |
| Comparative | 22.7 | 31.5 | X | 55 | 55 | X | X |
| Example 8 | | | | | | | |
| Comparative | 35.9 | 80.6 | X | 0 | 0 | ⊚ | Δ |
| Example 9 | | | | | | | |
| Comparative | 35.2 | 67.5 | X | 0 | 0 | ⊚ | Δ |
| Example 10 | | | | | | | |

### Synthesis Example 7

### Preparation of acrylic polymer solution (A)

A mixture of 200 g of 2-ethylhexyl acrylate, 8 g of 2-hydroxyethyl acrylate, 0.4 g of 2,2′-azobisisobutyronitrile, and 312 g of ethyl acetate was subjected to a reaction in a nitrogen stream at 65° C. for 6 hours to provide an acrylic polymer solution (A) (40 wt o) having a Tg of -68° C., a weight-average molecular weight of 500,000, and an acid value of 0.

### Synthesis Example 8

### Production of Pressure-Sensitive Adhesive Protective Sheet (A)

The acrylic polymer solution (A) obtained in Synthesis Example 7 was diluted to 20 wt % with ethyl acetate. To 100 g of the solution were added 0.8 g of an isocyanate-based cross-linking agent (CORONATE L, manufactured by Nippon Polyurethane Industry Co., Ltd.) and 0.4 g of dibutyltin dilaurate (1 wt % ethyl acetate solution) as a cross-linking catalyst to prepare an acrylic pressure-sensitive adhesive solution (A). The resultant acrylic pressure-sensitive adhesive solution (A) was applied to one surface of a vinyl chloride sheet (thickness: 120 μm) and heated at 110° C. for 3 minutes to form a pressure-sensitive adhesive layer having a thickness of 10 μm. Next, the silicone-treated surface of a separator was attached to a surface of the pressure-sensitive adhesive layer to produce a pressure-sensitive adhesive protective sheet (A).

### Synthesis Example 9

### Production of Pressure-Sensitive Adhesive Protective Sheet (B)

The same acrylic pressure-sensitive adhesive solution (A) as that used in Synthesis Example 8 was applied to the corona-treated surface of a polyolefin-based film (thickness: 150 μm), one surface of which had been subjected to corona treatment, and dried at 80° C. for 10 minutes to form a pressure-sensitive adhesive layer having a thickness of 10 μm. Next, the silicone-treated surface of a separator was attached to one surface of the pressure-sensitive adhesive layer to produce a pressure-sensitive adhesive protective sheet (B).

### Synthesis Example 10

### Production of Pressure-Sensitive Adhesive Protective Sheet (C)

A silicone-based releasing agent was applied to each of both surfaces of high-quality paper (glassine paper, density: 70 g/m², thickness: 130 μm), both the surfaces having been subjected to lamination treatment with polyethylene, to produce a release liner (sometimes referred to as “release liner A”). The pressure-sensitive adhesive composition (A) obtained in Synthesis Example 2 was applied to one surface of the release liner A so that the thickness after drying became 80 μm, and dried at a temperature of 110° C. for 3 minutes to form a pressure-sensitive adhesive layer D1. Thus, the release liner A having formed thereon the pressure-sensitive adhesive layer D1 was produced. The release liner A having formed thereon the pressure-sensitive adhesive layer D1 was laminated on and attached to one surface side of a rayon pulp nonwoven fabric (trade name “MR Base Paper (basis weight: 14 g/m²),” manufactured by Miki Tokushu Paper MFG. CO., LTD.) in such a manner that the pressure-sensitive adhesive layer D1 was brought into contact with the rayon pulp nonwoven fabric. Thus, a pressure-sensitive adhesive layer A with a nonwoven fabric was obtained.

The pressure-sensitive adhesive composition (A) obtained in Synthesis Example 2 was applied to one surface of another release liner (sometimes referred to as “release liner B”) having the same construction as that of the release liner A so that the thickness after drying became 80 μm, and dried at a temperature of 110° C. for 3 minutes to form a pressure-sensitive adhesive layer D2. Thus, the release liner B having formed thereon the pressure-sensitive adhesive layer D2 was produced. The release liner B having formed thereon the pressure-sensitive adhesive layer D2 was laminated and attached in such a manner that the nonwoven fabric surface of the pressure-sensitive adhesive layer A with a nonwoven fabric was brought into contact with the pressure-sensitive adhesive layer D2. Thus, a pressure-sensitive adhesive protective sheet (C) was produced.

### Example 21

### Pressure-Sensitive Adhesive Protective Sheet (A)/Aluminum Sheet (50 μm)/Pressure-Sensitive Adhesive Layer (A)

The pressure-sensitive adhesive layer (A) having a separator on one surface thereof obtained in Synthesis Example 3 was bonded onto an aluminum sheet (thickness: 50 μm) with a hand roller so that the aluminum sheet was brought into contact with the pressure-sensitive adhesive layer. Next, the separator was peeled off from the pressure-sensitive adhesive protective sheet (A) obtained in Synthesis Example 8. The resultant was bonded to the surface of the aluminum sheet with a hand roller to provide a pressure-sensitive adhesive sheet having an aluminum base material with a surface protective layer (21).

### Example 22

### Pressure-Sensitive Adhesive Protective Sheet (B)/Aluminum Sheet (50 μm)/Pressure-Sensitive Adhesive Layer (A)

The pressure-sensitive adhesive layer (A) having a separator on one surface thereof obtained in Synthesis Example 3 was bonded onto an aluminum sheet (thickness: 50 μm) with a hand roller so that the aluminum sheet was brought into contact with the pressure-sensitive adhesive layer. Next, the separator was peeled off from the pressure-sensitive adhesive protective sheet (B) obtained in Synthesis Example 9. The resultant was bonded to the surface of the aluminum sheet with a hand roller to provide a pressure-sensitive adhesive sheet having an aluminum base material with a surface protective layer (22).

### Example 23

### Pressure-Sensitive Adhesive Protective Sheet (C)/Aluminum Sheet (50 μm)/Pressure-Sensitive Adhesive Layer (A)

The pressure-sensitive adhesive layer (A) having a separator on one surface thereof obtained in Synthesis Example 3 was bonded onto an aluminum sheet (thickness: 50 μm) with a hand roller so that the aluminum sheet was brought into contact with the pressure-sensitive adhesive layer. Next, the release liner B was peeled off from the pressure-sensitive adhesive protective sheet (C) obtained in Synthesis Example 10. The resultant was bonded to the surface of the aluminum sheet with a hand roller to provide a pressure-sensitive adhesive sheet having an aluminum base material with a surface protective layer (23). The surface of the pressure-sensitive adhesive sheet having the aluminum base material with a surface protective layer (23) on the surface protective layer side is covered with the release liner A.

### Example 24

The separator covering the pressure-sensitive adhesive layer (A) was peeled off from the pressure-sensitive adhesive sheet having the aluminum base material with a surface protective layer (21) obtained in Example 21, and the pressure-sensitive adhesive layer (A) side was bonded onto a veneer board (thickness: 2.3 mm) with a hand roller to provide a composite member (17). The composite member (17) was subjected to evaluations.

### Example 25

The separator covering the pressure-sensitive adhesive layer (A) was peeled off from the pressure-sensitive adhesive sheet having the aluminum base material with a surface protective layer (22) obtained in Example 22, and the pressure-sensitive adhesive layer (A) side was bonded onto a veneer board (thickness: 2.3 mm) with a hand roller to provide a composite member (18). The composite member (18) was subjected to evaluations.

### Example 26

The separator covering the pressure-sensitive adhesive layer (A) was peeled off from the pressure-sensitive adhesive sheet having the aluminum base material with a surface protective layer (23) obtained in Example 23, and the pressure-sensitive adhesive layer (A) side was bonded onto a veneer board (thickness: 2.3 mm) with a hand roller to provide a composite member (19). The composite member (19) was subjected to evaluations.

### Example 27

The pressure-sensitive adhesive layer (A) having a separator on one side thereof obtained in Synthesis Example 3 was bonded onto an aluminum sheet (thickness: 50 μm) with a hand roller so that the aluminum sheet was brought into contact with the pressure-sensitive adhesive layer. Next, the separator was peeled off, and bonding was performed with a hand roller so that the pressure-sensitive adhesive layer (A) side was brought into contact with a veneer board (thickness: 2.3 mm), therebyproviding a composite member (20), a surface of which was constructed of an aluminum sheet. The composite member (20) was subjected to evaluations.

### Comparative Example 11

A veneer board (thickness: 2.3 mm) alone was subjected to evaluations.

### [Total Heat Release and Time for Heat Release by Cone Calorimeter Test]

A test piece having a planar square shape 99 mm on a side was cut out of an object to be evaluated (each of the composite members obtained in Examples and various members prepared in Comparative Examples). The test piece was irradiated with heat rays at 50 kW/m² using a cone calorimeter in conformity to a combustion test (ASTM E1354) to combust the test piece. A total heat release (MJ/m²) and a time for heat release exceeding 200 kW/m² (seconds) at each of an elapsed time of 10 minutes and an elapsed time of 20 minutes in the heating combustion of the test piece for 20 minutes were measured.
(Assessment Criteria)
(1) Total Heat Release
⊚: A total heat release of 8 MJ/m² or less in a period of 20 minutes.
∘: A total heat release of more than 8 MJ/m² in a period of 20 minutes and a total heat release of 8 MJ/m² or less in a period of 10 minutes.
×: A total heat release of more than 8 MJ/m² in a period of 10 minutes.
(2) Time for Heat Release Exceeding 200 kW/m²
⊚: A time for heat release exceeding 200 kW/m² (seconds) of less than 10 seconds in a period of 20 minutes.
∘: A time for heat release exceeding 200 kW/m² (seconds) of 10 seconds or more in a period of 20 minutes and a time for heat release exceeding 200 kW/m² (seconds) of less than 10 seconds in a period of 10 minutes.
×: A time for heat release exceeding 200 kW/m² (seconds) of 10 seconds or more in a period of 10 minutes.
(3) Crack/Perforation
∘: Absence of a crack or perforation detrimental to fire prevention.
Δ: Presence of a crack or perforation detrimental to fire prevention.
×: Disappearance.

### [Evaluation of Surface Protective Performance]

An object to be evaluated (each of the composite members obtained in Examples and various members prepared in Comparative Examples) was strongly rubbed with a flat-bladed screwdriver brought into contact with the fire-resistant pressure-sensitive adhesive tape side at an angle of 30° . In that case, whether or not the fire-resistant pressure-sensitive adhesive tape ruptured to expose an adherend serving as a ground was visually assessed. The evaluations were performed according to the following criteria.
∘: The fire-resistant pressure-sensitive adhesive tape does not rupture.
×: The fire-resistant pressure-sensitive adhesive tape ruptures to expose an adherend serving as a ground.

TABLE 2

| | | | | Time for heat | | | | |
|---|---|---|---|---|---|---|---|---|
| | Total heat | | | release exceeding | | | | Surface |
| | release (MJ/m²) | | | 200 kW/m² (seconds) | | | Crack/ | protective |
| | 10 minutes | 20 minutes | Assessment | 10 minutes | 20 minutes | Assessment | perforation | performance |
| Example 24 | 1.9 | 1.9 | ⊚ | 0 | 0 | ⊚ | ◯ | ◯ |
| Example 25 | 3.4 | 3.5 | ⊚ | 0 | 0 | ⊚ | ◯ | ◯ |
| Example 26 | 5.9 | 5.9 | ⊚ | 8 | 8 | ⊚ | ◯ | ◯ |
| Comparative | 24.0 | 24.5 | X | 31 | 31 | X | X | — |
| Example 11 | | | | | | | | |
| Example 27 | 0.1 | 0.1 | ⊚ | 0 | 0 | ⊚ | ◯ | X |

### INDUSTRIAL APPLICABILITY

The fire-resistant pressure-sensitive adhesive tape and fire-resistant construction material of the present invention can each be suitably used, for example, as a building material in each of an outer wall material, an outer wall trim material, an inner wall material, an inner wall trim material, an wall insulation material, a ceiling material, a ceiling trim material, a roofing material, a floor material, a floor trim material, a partition material, a wall material, floor material, and ceiling material for a bathroom and trim materials therefor, a wall material, floor material, and ceiling material for a kitchen and trim materials therefor, a wall material, floor material, and ceiling material for a lavatory and trim materials therefor, a pillar material and a pillar protection material, and an inner material, surface trim material, partition material, and curtain for a lavatory, room, and various doors such as a front door and a sliding door, in particular, a wall material and ceiling material for a kitchen, and a partition for a clean room, in general housing including wooden housing based on a conventional construction method, a light-frame construction method, or the like, reinforced concrete housing, steel construction housing of light-gauge steel construction or heavy-gauge steel construction, and prefabricated housing, complex housing such as a super high-rise condominium, a high-rise condominium, a mid-rise or low-rise condominium, and an apartment building, and large building structures and public facilities such as a cafe, a restaurant, an office building, a department store, a supermarket, an indoor parking lot, a movie theater, a hotel, various sports facilities, a gymnasium, a concert hall, a domed baseball stadium or soccer stadium, an indoor soccer stadium, an indoor pool, and a factory building. In addition, the tape and the material can each be used in, for example, an inner material or surface trim material for fire preventive equipment such as an exhaust duct, a fire door, or a fire shutter, a surface trim material for furniture such as a table, a surface trim material for a door, a surface trim material for window glass, a surface trim material for furniture such as a table, a shatterproofing material or surface trim material for window glass, a mirror, a tile, or the like, a surface trim material for a signboard or digital signage, or a roll screen. In addition, the tape and the material can each be used in a body protective material, inner or outer wall material, ceiling material, roofing material, floor material, or partition material for a ship, aircraft, automobile, or railway vehicle, a surface protective material for a printed matter to be bonded to the inside or outside of a railway vehicle, a surface protective material for an inkjet media material, an outer protective material or inner protective material for a solar cell, a protective material for a battery such as a lithium ion battery, or an electrical and electronic device member such as a partition inside an electrical device. Further, the tape and the material can each also be used as a peripheral tool for an ash tray, a surface trim material for a garbage can, or a protective material for the front panel or chassis of a pachinko machine.

### REFERENCE SIGNS LIST

1 surface protective layer
10 fire-resistant layer
20 pressure-sensitive adhesive layer
30 easy adhesion layer
40 opening
100 fire-resistant pressure-sensitive adhesive tape
200 member
1000 fire-resistant construction material

Listing of claims:

1. A fire-resistant pressure-sensitive adhesive tape, comprising:
a fire-resistant layer; and
a pressure-sensitive adhesive layer,
wherein the fire-resistant layer comprises aluminum.

2. A fire-resistant pressure-sensitive adhesive tape according to claim 1, further comprising a surface protective layer on a side of the fire-resistant layer opposite to the pressure-sensitive adhesive layer.

3. A fire-resistant pressure-sensitive adhesive tape according to claim 2, wherein the surface protective layer comprises at least one kind selected from a surface protective material including a polyvinyl chloride-based film as a base and a surface protective material including a polyolefin-based film as a base.

4. A fire-resistant pressure-sensitive adhesive tape according to claim 1, wherein a composite member obtained by bonding the fire-resistant pressure-sensitive adhesive tape to an adherend having a thickness of from 0.1 mm to 50 mm has a total heat release of 8 MJ/m² or less in heating combustion at an irradiance intensity of 50 kW/m² for 20 minutes by a cone calorimeter test in conformity to ASTM-E-1354.

5. A fire-resistant pressure-sensitive adhesive tape according to claim 1, wherein a composite member obtained by bonding the fire-resistant pressure-sensitive adhesive tape to an adherend having a thickness of from 0.1 mm to 50 mm has a time for heat release exceeding 200 kW/m² of less than 10 seconds in heating combustion at an irradiance intensity of 50 kW/m² for 20 minutes by a cone calorimeter test in conformity to ASTM-E-1354.

6. A fire-resistant pressure-sensitive adhesive tape according to claim 1, wherein a composite member obtained by bonding the fire-resistant pressure-sensitive adhesive tape to an adherend having a thickness of from 0.1 mm to 50 mm is free of a crack or perforation reaching a back surface thereof after heating combustion at an irradiance intensity of 50 kW/m² for 20 minutes by a cone calorimeter test in conformity to ASTM-E-1354.

7. A fire-resistant pressure-sensitive adhesive tape according to claim 1, wherein the fire-resistant layer has a thickness of from 5 μm to 300 μm.

8. A fire-resistant pressure-sensitive adhesive tape according to claim 1, wherein the fire-resistant layer comprises any one of an aluminum foil, a laminate in which an aluminum foil is laminated, and a glass cloth aluminum foil.

9. A fire-resistant pressure-sensitive adhesive tape according to claim 1, wherein the pressure-sensitive adhesive layer comprises an acrylic pressure-sensitive adhesive.

10. A fire-resistant pressure-sensitive adhesive tape according to claim 1, wherein the fire-resistant layer partially has an opening.

11. A fire-resistant pressure-sensitive adhesive tape according to claim 1, wherein the pressure-sensitive adhesive layer has a thickness of from 5 gm to 2 mm.

12. A fire-resistant construction material, comprising:
a member; and
the fire-resistant pressure-sensitive adhesive tape according to claim 1 bonded to at least one surface of the member.

13. A fire-resistant construction material according to claim 12, wherein the member comprises a combustible member.

14. A fire-resistant construction material according to claim 12, wherein the combustible member comprises at least one kind selected from paper, a lumber board, and a resin board.

15. A fire-resistant construction material according to claim 12, wherein the member has a thickness of from 0.1 mm to 50 mm.

16. A fire-resistant construction material according to claim 12, wherein the fire-resistant construction material has a total heat release of 8 MJ/m² or less in heating combustion at an irradiance intensity of 50 kW/m² for 20 minutes by a cone calorimeter test in conformity to ASTM-E-1354.

17. A fire-resistant construction material according to claim 12, wherein the fire-resistant construction material has a time for heat release exceeding 200 kW/m² of less than 10 seconds in heating combustion at an irradiance intensity of 50 kW/m² for 20 minutes by a cone calorimeter test in conformity to ASTM-E-1354.

18. A fire-resistant construction material according to claim 12, wherein the fire-resistant construction material is free of a crack or perforation reaching a back surface thereof after heating combustion at an irradiance intensity of 50 kW/m² for 20 minutes by a cone calorimeter test in conformity to ASTM-E-1354.

19. A fire-resistant treatment method, comprising using the fire-resistant pressure-sensitive adhesive tape according to claim 1.
